(19) United States
(12) Patent Application Publication
(10) Pub. No.: US 2023/0179097 A1
(43) Pub. Date: Jun. 8, 2023

(54) Switching Power Device

(71) Applicant: ROHM CO., LTD., KYOTO (JP)

(72) Inventor: Genki Tsuruyama, KYOTO (JP)

(21) Appl. No.: 18/070,836

(22) Filed: Nov. 29, 2022

(30) Foreign Application Priority Data
Dec. 3, 2021 (JP) 2021197257

(51) Int. Cl. H02M 3/158; H02M 1/08; B60R 16/02

(52) U.S. Cl. CPC H02M 3/158; H02M 1/083; B60R 16/02

(57) ABSTRACT

The present disclosure provides a switching power device. A control unit of the switching power device includes a first state, a second state, a third state and a fourth state. In the first state, a first switch is turned on, and a second switch is turned off. In the second state, the first switch is turned off, and the second switch is turned on. In the third state, the first and second switches are turned off. In the fourth state, a voltage of a connection node of the first and second switches is less than that in the third state. The control unit repeats the first state, the second state, the third state, and the fourth state, and lengthens a period of the fourth state as an input voltage increases.

### TECHNICAL FIELD

The disclosure of the application relates to a switching power device that steps down an input voltage to an output voltage.

### BACKGROUND

In the prior art, a switching power device (for example, referring to patent publication 1) with a fixed on-time control means is available as a high-efficiency switching power device for a light load.

### PRIOR ART DOCUMENT

### Patent Publication

[Patent document 1] Japan Patent Publication No. 2010-35316

### SUMMARY

### Problems to be Solved by the Disclosure

A switching power device with a fixed on-time control means features a variable switching frequency according to the status of a load. When the switching frequency varies, the frequency of noise also changes, hence sometimes resulting degradation of effects of a noise suppression mechanism (for example, a filter circuit) that suppresses noise of a fixed frequency. Therefore, it is desired that the switching frequency of a switching power device stay stable as much as possible in an environment with a noise issue.

Further, it is desired that the switching power device also be highly efficient when a value of an input voltage changes.

### Technical Means for Solving the Problem

A switching power device disclosed in the present application is a switching power device configured to step down an input voltage to an output voltage. The switching power device includes: a first switch, having a first end connectable to an application end of the input voltage, and a second end connectable to a first end of an inductor; a second switch, having a first end connectable to the first end of the inductor and the second end of the first switch, and a second end connectable to a low voltage application end having a voltage less than the input voltage; and a control unit, configured to control on/off of the first switch and the second switch. The control unit includes: a first state, in which the first switch is on and the second switch is off; a second state, in which the first switch is off and the second switch is on; a third state, in which the first switch and the second switch are off; and a fourth state, in which a voltage of a connection node between the first switch and the second switch is less than that in the third state. The control unit repeats the first state, the second state, the third state and the fourth state, and when the input voltage is increased, a duration of the fourth state is lengthened.

According to an aspect of the disclosure, a switch control device controls on/off of a first switch and on/off of a second switch. The first switch has a first end connectable to an application end of an input voltage, and a second end connectable to a first end of an inductor. The second switch has a first end connectable to the first end of the inductor and the second end of the first switch, and a second end connectable to a low voltage application end having a voltage less than the input voltage. The switch control device includes: a first state, in which the first switch is on and the second switch is off; a second state, in which the first switch is off and the second switch is on; a third state, in which the first switch and the second switch are off; and a fourth state, in which a voltage of a connection node between the first switch and the second switch is less than that in the third state. The switch control device repeats the first state, the second state, the third state and the fourth state, and when the input voltage is increased, a duration of the fourth state is lengthened.

A vehicle device provided according to one aspect of the disclosure includes the switching power device of the above configurations or the switch control device of the above configurations.

A vehicle provided according to one aspect of the disclosure includes the vehicle device of the above configuration, and a battery supplying power to the vehicle device.

### Effects of the Disclosure

According to an aspect of the disclosure, high efficiency can be achieved regardless of a value of an input voltage.

### BRIEF DESCRIPTION OF THE DRAWINGS

FIG. 1 is a diagram of a configuration of a switching power supply device according to a first embodiment.

FIG. 2 is a timing diagram of operations of a switching power supply device according to the first embodiment.

FIG. 3 is a diagram of a configuration of a switching power supply device according to a second embodiment.

FIG. 4 is a timing diagram of operations of a switching power supply device according to the second embodiment.

FIG. 5 is a diagram of a configuration of a switching power supply device according to a third embodiment.

FIG. 6 is a timing diagram of operations of a switching power supply device according to the third embodiment.

FIG. 7 is a diagram of a configuration of a switching power supply device according to a fourth embodiment.

FIG. 8 is a timing diagram of operations of a switching power supply device according to the fourth embodiment.

FIG. 9 is a diagram of a first configuration example of a control unit according to a fifth embodiment.

FIG. 10 is a timing diagram of operations of the control unit in FIG. 9.

FIG. 11 is a diagram of a second configuration example of a control unit according to the fifth embodiment.

FIG. 12 is a timing diagram of operations of the control unit in FIG. 11.

FIG. 13 is a diagram of a third configuration example of a control unit according to the fifth embodiment.

FIG. 14 is a timing diagram of operations of the control unit in FIG. 13.

FIG. 15 is a diagram of a first configuration example of a control unit according to a sixth embodiment.

FIG. 16 is a timing diagram of operations of the control unit in FIG. 15.

FIG. 17 is a diagram of a second configuration example of a control unit according to a sixth embodiment.

FIG. 18 is a timing diagram of operations of the control unit in FIG. 17.

FIG. 19 is a diagram of a first configuration example of a setting circuit according to a seventh embodiment.

FIG. 20 is a timing diagram of operations of the setting circuit in FIG. 19.

FIG. 21 is a diagram of a second configuration example of a setting circuit according to the seventh embodiment.

FIG. 22 is a timing diagram of operations of the setting circuit in FIG. 21.

FIG. 23 is a diagram of a first configuration example of a control unit according to an eighth embodiment.

FIG. 24 is a timing diagram of operations of the control unit in FIG. 23.

FIG. 25 is a diagram of a second configuration example of a control unit according to the eighth embodiment.

FIG. 26 is a timing diagram of operations of the control unit in FIG. 25.

FIG. 27 is a diagram of a third configuration example of a control unit according to the eighth embodiment.

FIG. 28 is a timing diagram of operations of the control unit in FIG. 27.

FIG. 29 is a diagram of a first configuration example of a control unit according to a ninth embodiment.

FIG. 30 is a timing diagram of operations of the control unit in FIG. 29.

FIG. 31 is a diagram of a second configuration example of a control unit according to the ninth embodiment.

FIG. 32 is a timing diagram of operations of the control unit in FIG. 31.

FIG. 33 is a diagram of a third configuration example of a control unit according to the ninth embodiment.

FIG. 34 is a timing diagram of operations of the control unit in FIG. 33.

FIG. 35 is a diagram of a configuration example of a vehicle.

### DETAILED DESCRIPTION OF THE EMBODIMENTS

In the disclosure, a metal oxide semiconductor (MOS) transistor refers to a transistor in which a gate has at least three layers including “a layer containing a conductor or a semiconductor such as polysilicon with a small resistance value”, “an insulating layer”, and “a P-type, N-type or intrinsic semiconductor layer”. That is to say, the gate structure of the MOS transistor is not limited to the structure of the three layers including metal, oxide and semiconductor.

In the disclosure, a reference voltage refers to a fixed voltage in an ideal state, and is in practice a voltage slightly variable in response to temperature changes.

In the disclosure, a constant voltage refers to a fixed voltage in an ideal state, and is in practice a voltage slightly variable in response to temperature changes.

In the disclosure, a constant current refers to a fixed current in an ideal state, and is in practice a current slightly variable in response to temperature changes.

### First Embodiment

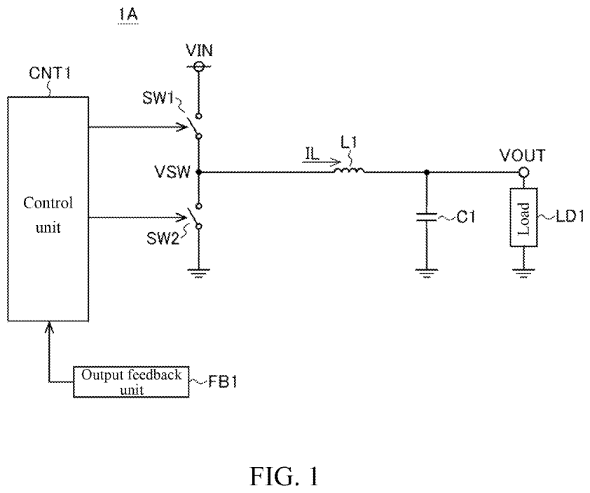

FIG. 1 shows a diagram of a configuration of a switching power supply device according to a first embodiment. The switching power device 1A of the first embodiment (to be referred to as a switching power device 1A″ hereinafter) is a switching power supply configured to step down an input voltage VIN to an output voltage VOUT, and includes a control unit CNT1, a first switch SW, a second switch SW2, an inductor L1, an output capacitor C1 and an output feedback unit FB1. The switching power device IA may be configured to operate in a current continuous mode for light loads, or may configured to have a reverse current prevention function and operate in a current discontinuous mode for light loads.

The control unit CNT1 controls on/off of the first switch SW1 and the second switch SW2 based on an output of the output feedback unit FB1. In other words, the control unit CNT1 is a switch control device that controls on/off of the first switch SW1 and the second switch SW2.

The first switch SW1 has a first end connectable to an application end of the input voltage VIN, and a second end connectable to a first end of the inductor L1. The first switch SW1 connects/disconnects a current path from the application end of the input voltage VIN to the inductor L1. The first switch SW1 can be implemented by, for example, a P-channel MOS transistor or an N-channel MOS transistor. For example, when the first switch SW1 is implemented by an N-channel MOS transistor, to generate a voltage greater than the input voltage VIN, a bootstrap circuit is disposed at the switching power device 1A.

The second switch SW2 has a first end connectable to the first end of the inductor L1 and the second end of the first switch, and a second end connectable to a ground potential application end. The second switch SW2 connects/disconnects a current path from the ground potential application end to the inductor L1. The second switch SW2 can be implemented by, for example, an N-channel MOS transistor.

By switching the first switch SW1 and the second switch SW2, a pulsed switching voltage VSW is generated at a connection node between the first switch SW1 and the second switch SW2. The inductor L1 and the output capacitor C1 smooth the pulsed switching voltage VSW, generate the output voltage VOUT, and supply the output voltage VOUT to an application end of the output voltage VOUT. A load LD1 is connected to the application end of the output voltage VOUT, and the output voltage VOUT is supplied to the load LD1.

The output feedback unit FB1 generates and outputs a feedback signal corresponding to the output voltage VOUT. The output feedback unit FB1 can be implemented by, for example, a resistor voltage divider circuit that resistively divides the output voltage VOUT to generate a feedback signal. Moreover, the output feedback unit FB1 can also be configured to obtain the output voltage VOUT and output the output voltage VOUT itself as the feedback signal. In addition, in addition to the feedback signal corresponding to the output voltage VOUT, the output feedback unit FB1 may be configured to further generate and output a feedback signal corresponding to a current flowing through the inductor L1 (to be referred to as “an inductor current IL” hereinafter). A feedback signal corresponding to the inductor current IL is also generated by the output feedback unit FB1 to perform current mode control.

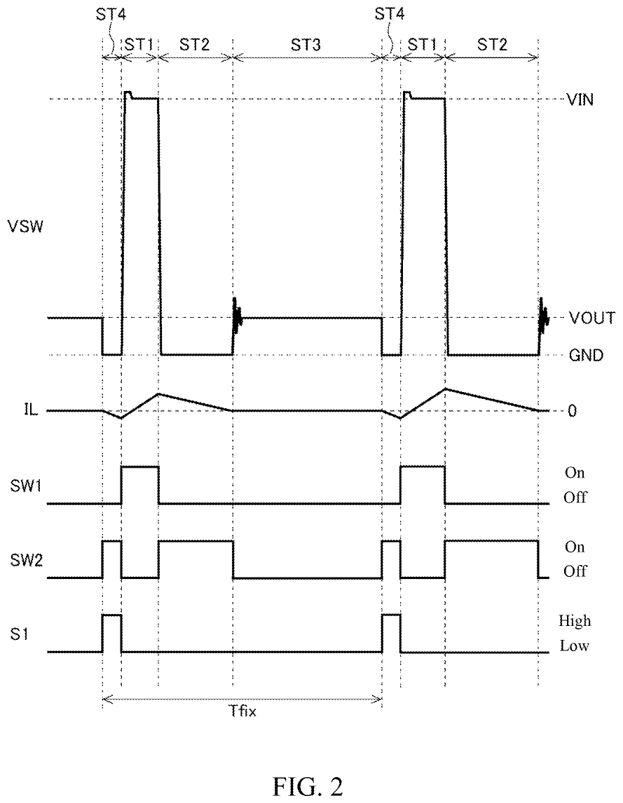

FIG. 2 shows a timing diagram of operations of the switching power supply device 1A. The control unit CNT1 sets a duration of a first state ST1 according to the feedback signal output from the output feedback unit FB1. The duration of the first state ST1 shortens as the load of the load LD1 gets lighter.

In the first state ST1, the control unit CNT1 turns on the first switch SWl and turns off the second switch SW2. In the first state ST1, the switching voltage VSW becomes a value obtained by adding a forward voltage of a body diode of the first switch SW1 to the input voltage VIN, and then becomes a value substantially the same as the input voltage VIN. In the first state ST1, the inductor current IL increases as time elapses.

When the first state ST1 ends, the control unit CNT1 switches the control status from the first state ST1 to a second state ST2.

In the second state ST2, the control unit CNT1 turns off the first switch SW1 and turns on the second switch SW2. In the second state ST2, the switching voltage VSW becomes a value substantially the same as the ground potential GND. In the second state ST2, the inductor current IL decreases as time elapses.

When the inductor current IL decreases to a predetermined value, the control unit CNT1 ends the second state ST2, and switches the control status from the second state ST2 to a third state ST3. A determination unit (not shown) that determines whether the inductor current IL has decreased to a predetermined value can be disposed separately from the control unit CNT1, or may be built-in the control unit CNT1. Moreover, in this embodiment, the predetermined value is set to zero.

In the third state ST3, the control unit CNT1 turns off the first switch SW1 and the second switch SW2. In the third state ST3, the connection node between the first switch SW1 and the second switch S2 becomes a high-impedance state, and the switching voltage VSW becomes a value substantially the same as the output voltage VOUT. In the second state ST2, the inductor current IL becomes zero.

A period signal S1 is a signal that generates pulses in a fixed period Tfix. The period signal S1 may be a signal generated in the control unit CNT1, or may be generated outside the control unit CNT1 and be obtained by the control unit CNT1.

When the pulse of the period signal S1 rises, the control unit CNT1 ends the third state ST3, and switches the control status from the third state ST3 to a fourth state ST4.

In the fourth state ST4, the control unit CNT1 turns off the first switch SW1 and turns on the second switch SW2. In the fourth state ST4, the switching voltage VSW becomes a value substantially the same as the ground potential GND. In the fourth state ST4, the inductor current IL flows from the application end of the output voltage VOUT to the connection node between the first switch SW1 and the second switch SW2, and the amount of current increases as time elapses. In the fourth state ST4, the inductor current IL is regenerated. The regenerated energy of the inductor current IL is released when the fourth state ST4 is switched to the first state ST1, and accordingly, the switching voltage VSW drastically rises when the fourth state ST4 is switched to the first state ST1.

When the pulse of the period signal S1 falls, the control unit CNT1 ends the fourth state ST4, and switches the control status from the fourth state ST4 to the first state ST1.

The control unit CNT1 repeats the first state ST1, the second state ST2, the third state ST3 and the fourth state ST4 in the fixed period Tfix. In addition, it is desired that a dead time period in which both of the first switch and the second switch are turned off is provided between the first state ST1 and the second state ST2, and between the fourth state ST4 and the first state ST1. When the dead time period is provided between the first state ST1 and the second state ST2, and between the fourth state ST4 and the first state ST1, the fixed period Tfix is consistent with a total of the dead time periods provided in the first state ST1 and between the first state ST1 and the second state ST2, and the dead time periods provided in the second state ST2, the third state ST3 and the fourth state ST4 and between the fourth state ST4 and the first state ST1.

Since the switching power device IA is configured to operate by way of the fixed period Tfix and not generate loss in the third state ST3, high efficiency is achieved without varying the switching frequency. When the load LD1 is a light load, the duration of the first state ST1 is shortened and the duration of the third state ST3 is lengthened, and so the switching power device 1A is capable of significantly improving the efficiency when the load LD1 is a light load.

In a variation example of this embodiment, the second switch SW2 may also be configured to have a second end connectable to a low voltage application end having a voltage other than the ground potential and less than the input voltage VIN.

### Second Embodiment

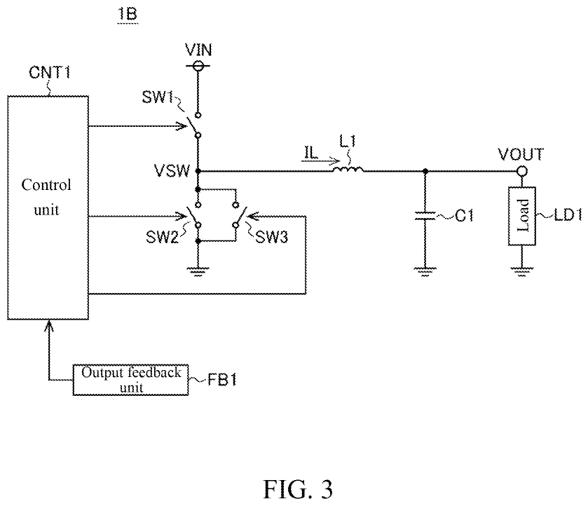

In the second embodiment, the description of configuration and operation details identical to those of the first embodiment is omitted herein. FIG. 3 shows a diagram of a configuration of a switching power supply device according to a second embodiment. A switching power device 1B of the second embodiment (to be referred to as “a switching power device 1B” hereinafter) has a configuration in which a switch SW3 is added to the switching power device 1A.

The switch SW3 is connected in parallel to the switch SW2. That is to say, a first end of the switch SW3 is connected to the first end of the switch SW2, and a second end of the switch SW3 is connected to the second end of the switch SW2. The third switch SW3 can be implemented by, for example, an N-channel MOS transistor. In addition to controlling on/off of the first switch SW1 and the second switch SW2, the control unit CNT1 further controls on/off of the third switch SW3.

At least one of an on-resistance (a resistance between the first end and the second end when turned on) and a capacitance (a parasitic capacitance between the first end and the second end) of the switch SW3 is less than that of the switch SW2.

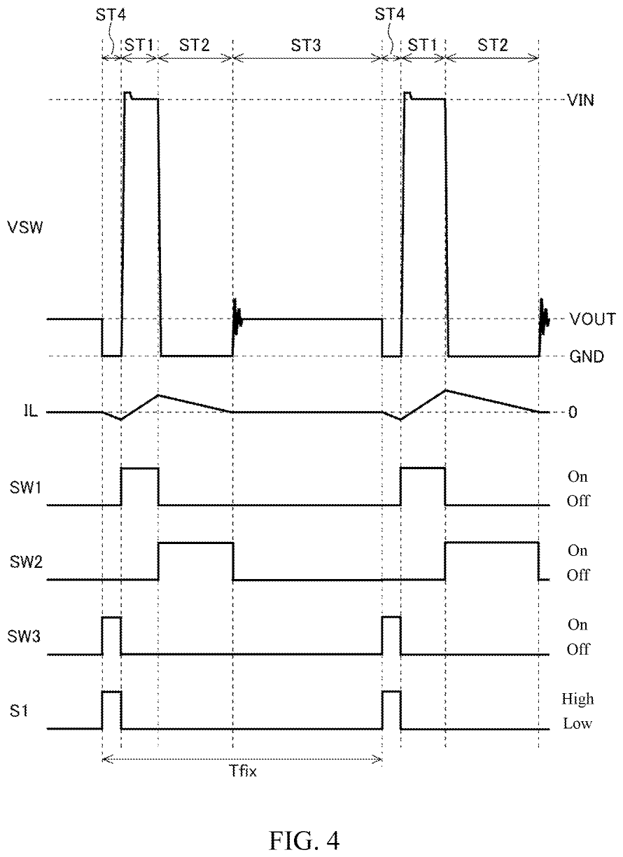

FIG. 4 shows a timing diagram of operations of the switching power supply device 1B. A difference in the operations of the switching power device 1B from the operations of the switching power device 1A is that, in the fourth state ST4, the control unit CNT1 turns off the second switch SW2.

In the fourth state ST4, the control unit CNT1 turns on the third switch SW3 in substitution to the second switch SW2. As described above, since at least one of the on-resistance and the capacitance of the switch SW3 is less than that of the second switch SW2, the switching power device 1B is capable of reducing loss in the fourth state ST4 compared to the switching power device 1A.

On the other hand, in first state ST1, the second state ST2 and the third state ST3, the control unit CNT1 turns off the third switch SW3.

Since the switching power device 1B is configured to operate by way of the fixed period Tfix and not generate loss in the third state ST3, high efficiency is achieved without varying the switching frequency. When the load LD1 is a light load, the duration of the first state ST1 is shortened and the duration of the third state ST3 is lengthened, and so the switching power device 1B is capable of significantly improving the efficiency when the load LD1 is a light load.

In a variation example of this embodiment, in the fourth state ST4, the control unit CNT1 can also turn on both of second switch SW2 and the third switch SW3.

Moreover, in a variation example of this embodiment, the second end of the second switch SW2 and the second end of the third switch SW3 may also be configured to be connectable to a low voltage application end having a voltage other than the ground potential and less than the input voltage VIN.

### Third Embodiment

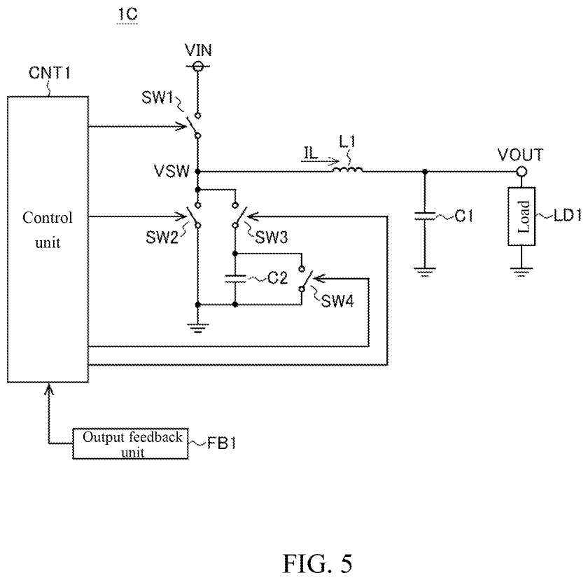

In the third embodiment, the description of configuration and operation details identical to those of the second embodiment is omitted herein. FIG. 5 shows a diagram of a configuration of a switching power supply device according to a third embodiment. A switching power device 1C of the third embodiment (to be referred to as “a switching power device IC” hereinafter) has a configuration in which the switch SW3, a capacitor C2 and a switch SW4 are added to the switching power device 1A.

The switch SW3 has a first end connected to the connection node between the first switch SW1 and the second switch SW2. The switch SW3 has a second end connected to a first end of the capacitor C2 and a first end of the fourth switch SW4. The capacitor C2 has a second end and the fourth switch SW4 has a second end both connected to the ground potential. The third switch SW3 can be implemented by, for example, an N-channel MOS transistor. The fourth switch SW4 can be implemented by, for example, an N-channel MOS transistor. In addition to controlling on/off of the first switch SW1 and the second switch SW2, the control unit CNT1 further controls on/off of the third switch SW3 and the fourth switch SW4.

At least one of an on-resistance (a resistance between the first end and the second end when turned on) and a capacitance (a parasitic capacitance between the first end and the second end) of the switch SW3 is less than that of the switch SW2. Moreover, different from this embodiment, the on-resistance and the capacitance of the switch SW3 may also be the same as those of the switch SW2.

The switch SW4 is a switch used to discharge the capacitor C2. When the switch SW4 becomes turned on, two ends of the capacitor C2 are shorted and the capacitor C2 is discharged.

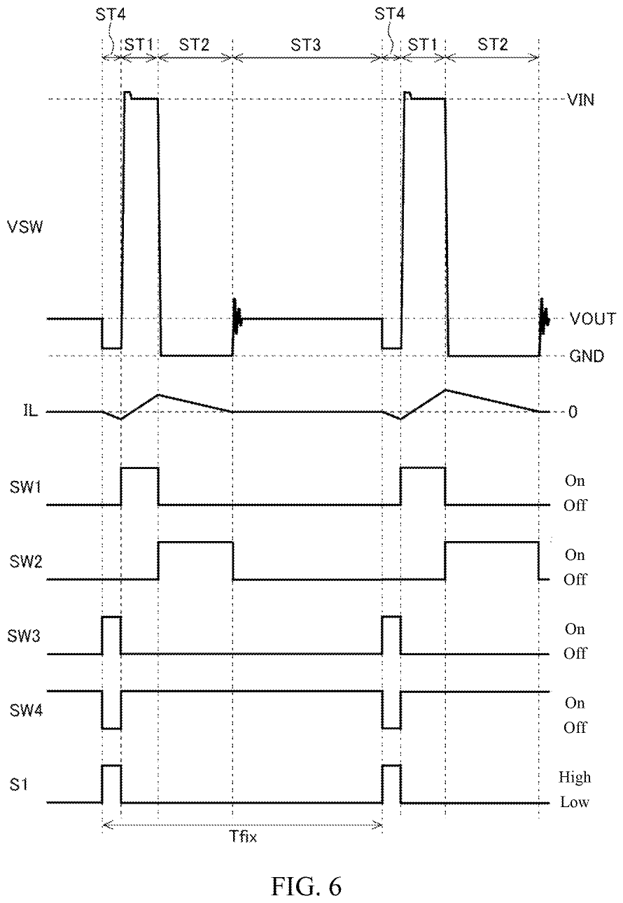

FIG. 6 shows a timing diagram of operations of the switching power supply device 1C. The operations of the switching power device 1C are fundamentally identical to those of the switching power device 1B. In the switching power device 1C, the control unit CTN1 is further configured to control on/off of the fourth switch SW4. The control unit CNT controls on/off of the third switch SW3 and on/off of the fourth switch SW4 in a complementary manner. That is to say, the control unit CTN1 turns on the fourth switch SW4 in the first state ST1, the second state ST2 and the third state ST3, and turns off the fourth switch SW4 in the fourth state ST4.

In the switching power device 1C, in the fourth state ST4, the switching voltage VSW becomes a voltage formed by capacitively dividing the input voltage VIN according to the parasitic capacitance between the first end and the second end of the first switch SW1, the parasitic capacitance between the first end and the second end of the switch SW3 and the capacitor C2. Accordingly, a value of the switching voltage VSW in the fourth state ST4 can be adjusted through a static capacitance value of the capacitor C2. That is to say, the rise in the switching voltage VSW when the fourth state ST4 is switched to the first state ST1 can be adjusted through the static capacitance value of the capacitor C2.

For example, a semiconductor integrated circuit is configured to include the control unit CNT1 and the capacitor C2 is set as an external component of the semiconductor integrated circuit, so that the value of the switching voltage VSW in the fourth state ST4 can be easily adjusted.

Since the switching power device 1C is configured to operate by way of the fixed period Tfix and not generate loss in the third state ST3, high efficiency is achieved without varying the switching frequency. When the load LD1 is a light load, the duration of the first state ST1 is shortened and the duration of the third state ST3 is lengthened, and so the switching power device 1C is capable of significantly improving the efficiency when the load LD1 is a light load.

Moreover, in a variation example of this embodiment, the second end of the second switch SW2, the second end of the capacitor C2 and the second end of the fourth switch SW4 may also be configured to be connectable to a low voltage application terminal having a voltage other than the ground potential and less than the input voltage VIN.

### Fourth Embodiment

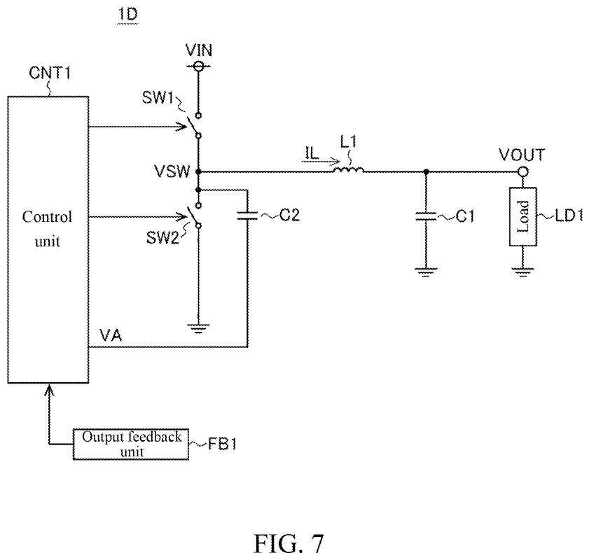

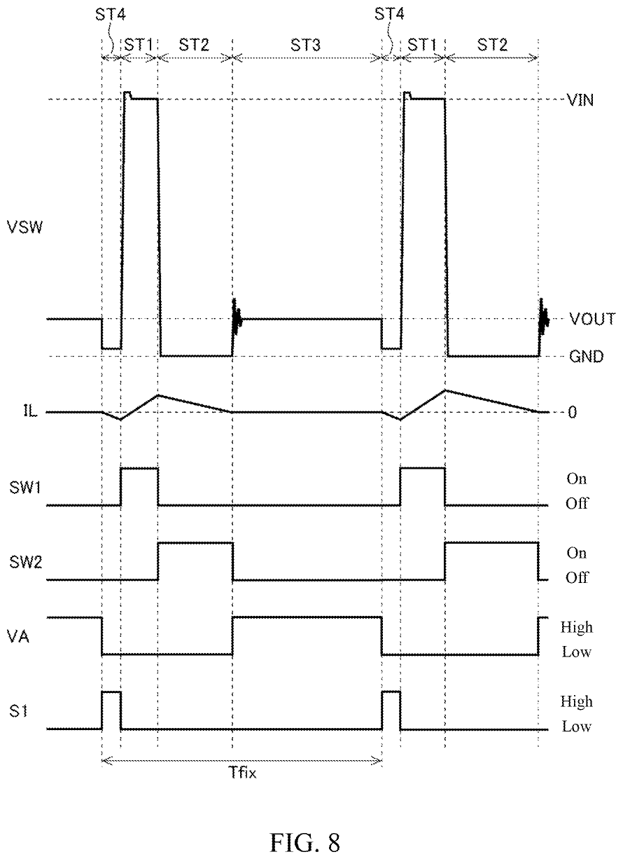

In the fourth embodiment, the description of configuration and operation details identical to those of the third embodiment is omitted herein. FIG. 7 shows a diagram of a configuration of a switching power supply device according to a fourth embodiment. A switching power device 1D of the fourth embodiment (to be referred to as “a switching power device ID” hereinafter) has a configuration in which a capacitor C2 is added to the switching power device 1A.

The capacitor C2 has a first end connected to the connection node between the first switch SW1 and the second switch SW2. The control unit CNT1 controls a voltage VA applied to the second end of the switch SW3. For example, the control unit CNT1 sets the voltage VA to a high level (HIHG, for example, a value the same as the output voltage VOUT) in the third state ST3, and sets the voltage VA to a low level (LOW, for example, the ground potential GND) in the first state ST1, the second state ST2 and the fourth state ST4.

The rise in the switching voltage VSW when the fourth state ST4 is switched to the first state ST1 can be adjusted by adjusting the value of the voltage VA in the fourth state ST4.

Since the switching power device 1D is configured to operate by way of the fixed period Tfix and not generate loss in the third state ST3, high efficiency is achieved without varying the switching frequency. When the load LD1 is a light load, the duration of the first state ST1 is shortened and the duration of the third state ST3 is lengthened, and so the switching power device 1D is capable of significantly improving the efficiency when the load LD1 is a light load.

Moreover, in a variation example of this embodiment, the second switch SW2 may also be configured to have a second end connectable to a low voltage application terminal having a voltage other than the ground potential and less than the input voltage VIN.

### Fifth Embodiment

In the control unit CNT1 of the switching power device of each of the first to fourth embodiments, the duration of the first state ST1 shortens as the load of the load LD1 gets lighter. That is to say, in the switching power devices of the first to fourth embodiments, it is gets more difficult to generate the control signal as the pulse width of the control signal used to control the switch SWI gets narrower.

The switching power device of the fifth embodiment is a switching power device capable solving the above issue of the switching power devices of the first to fourth embodiments.

The switching power device of the fifth embodiment is a switching power device improved from the switching power device of the first embodiment. Thus, in the fifth embodiment, the description of configuration and operation details identical to those of the first embodiment is omitted herein.

The control unit CNT1 of the fifth embodiment repeats the first state ST1, the second state ST2, the third state ST3 and the fourth state ST4 in a fixed period when the load LD1 is within a first range (usually a negative load). Thus, when the load LD1 is within the first range, the switching power device of the fifth embodiment is capable of fixing the switching frequency.

When the load LD1 is within a second range (a light load state) of a load lighter than the first range, the load LD1 is lighter, the period is longer, and the control unit CNT1 of the fifth embodiment repeats the first state ST1, the second state ST2, the third state ST3 and the fourth state ST4. Thus, the switching power device of the fifth embodiment inhibits the pulse width of the control signal used to control the switch SW1 from getting narrower when the load LD1 is within the second range. That is to say, in the switching power device of the fifth embodiment, normal switching control can be easily performed even when the load LD1 is in a light load state.

The control unit CTN1 of the fifth embodiment sets a dead time period DT, in which the first switch SW1 and the second switch SW2 are turned off, between the fourth state ST4 and the first state ST1. Moreover, without any part deviations, the control unit CNT1 of the fifth embodiment sets the duration of the dead time period DT and the duration of the fourth state ST4 to fixed values, respectively, by way of initiating the first state ST1 at a zero crossing point of the inductor current IL. Accordingly, the switching power device of the fifth configuration is capable of reducing loss when the first switch is on, hence further achieving high efficiency.

### First Configuration Example of Control Unit of Fifth Embodiment

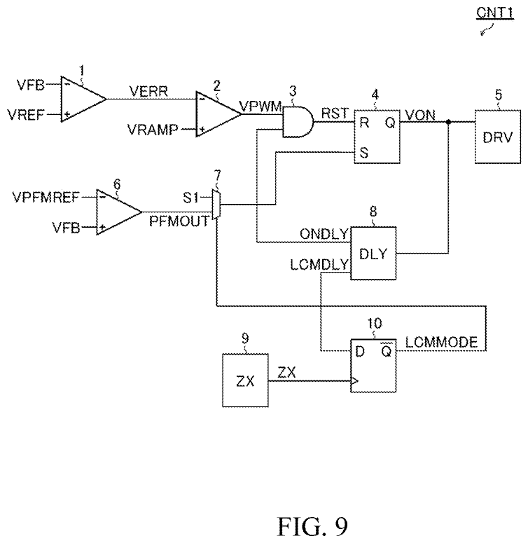

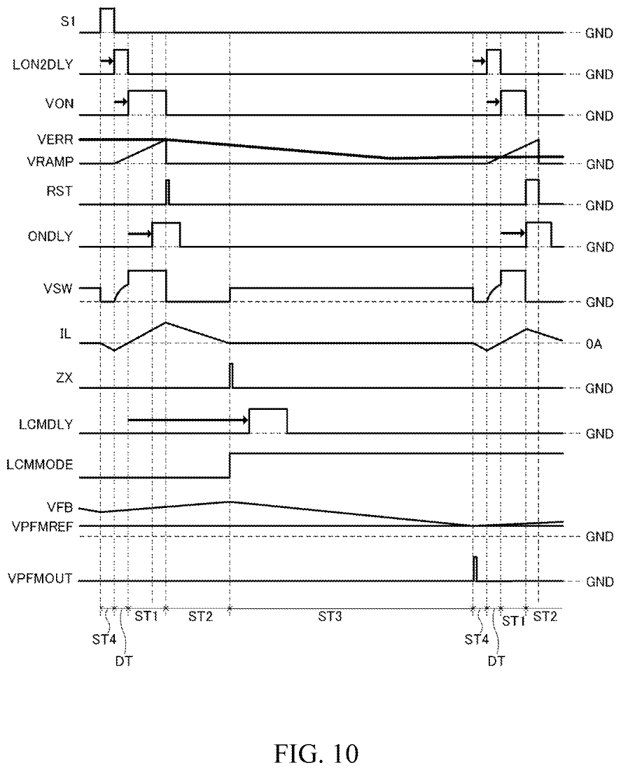

FIG. 9 shows a diagram of a first configuration example of the control unit CNT1 according to the fifth embodiment. FIG. 10 shows a timing diagram of operations of the control unit CNT1 in FIG. 9.

The control unit CNT1 in FIG. 9 includes an error amplifier 1, a pulse-width modulation (PWM) comparator 2, an AND gate 3, a latch circuit 4, a driver 5, a pulse-frequency modulation (PFM) comparator 6, a selector 7, a delay circuit 8, a zero crossing point detection circuit 9, and a latch circuit 10. In the configuration shown in FIG. 9, an RS flip-flop is used as an example of the latch circuit 4, and a D flip-flop is used as an example of the latch circuit 10. Thus, the following description is given by setting an RS flip-flop 4 as the latch circuit 4 and setting a D flip-flop 10 as the latch circuit 10.

The error amplifier 1 outputs an error signal VERR corresponding to a difference between the feedback signal VFB output from the output feedback unit FBI and a reference voltage VREF.

The PWM comparator 2 outputs a comparison result of the error signal VERR and a ramp voltage VRAMP, that is, a PWM signal VPWM.

The AND gate 3 outputs a logical product of the PWM signal VPWM and a delay signal ONDLY, that is, a reset signal RST. Details of the delay signal ONDLY are to be described below.

The RS flip-flop 4 delays in the RS flip-flop 4 a signal supplied to a setting terminal (an S terminal) to generate a delay signal LON2DLY. The RS flip-flop 4 generates and outputs an on-time setting voltage VON set by the delay signal LON2DLY and reset by a reset signal RST.

The driver 5 controls the first switch SW1 and the second switch SW2 based on the on-time setting voltage VON.

The PFM comparator 6 outputs a signal VPFMOUT corresponding to a difference between the feedback signal VFB output from the output feedback unit FB1 and a reference voltage VPFMREF. In the signal VPFMOUT, a pulse is generated when the output voltage VOUT does not reach a predetermined value.

The selector 7 selects and supplies either of the period signal S1 and the signal VPFMOUT to a setting terminal (an S terminal) of the RS flip-flop 4. The selector 7 selects the period signal S1 when a light load mode signal LCMMODE is at a low level. The selector 7 selects the signal VPFMOUT when the light load mode signal LCMMODE is at a high level. Details of the light load mode signal LCMMODE are to be described below.

The delay circuit 8 generates the delay signal ONDLY that delays the on-time setting voltage VON by a first predetermined time. The delay circuit 8 generates the delay signal LCMDLY that delays the on-time setting voltage VON by a second predetermined time. The second predetermined time is longer than the first predetermined time.

The zero crossing point detection circuit 9 detects a zero crossing point of the inductor current IL, and outputs a zero crossing point detection signal ZX. The zero crossing point detection signal ZX output from the zero crossing point detection circuit 9 becomes a high level when the inductor current IL decreases from positive and reaches the zero crossing point.

The D flip-flow 10 stores the delay signal LCMDLY in synchronization with the zero crossing point detection signal ZX, and outputs an inverted signal of the stored delay signal LCMDLY. The inverted signal of the delay signal LCMDLY stored by the D flip-flop 10 is the light load mode signal LCMMODE.

The control unit CNT 1 shown in FIG. 9 determines that the load LD1 is in a light load state when a time from a starting time point of the first state ST1 to the detection of the zero crossing point of the inductor current IL does not reach a certain value (the second predetermined time).

The control unit CNT1 shown in FIG. 9 uses the delay signal ONDLY, and sets a minimum time (the first predetermined time) of the first state ST1 when the load LD1 is in a light load state. Accordingly, the duration of the first state ST1 does not become inadequately short, hence better facilitating normal switch control.

### Second Configuration Example of Control Unit of Fifth Embodiment

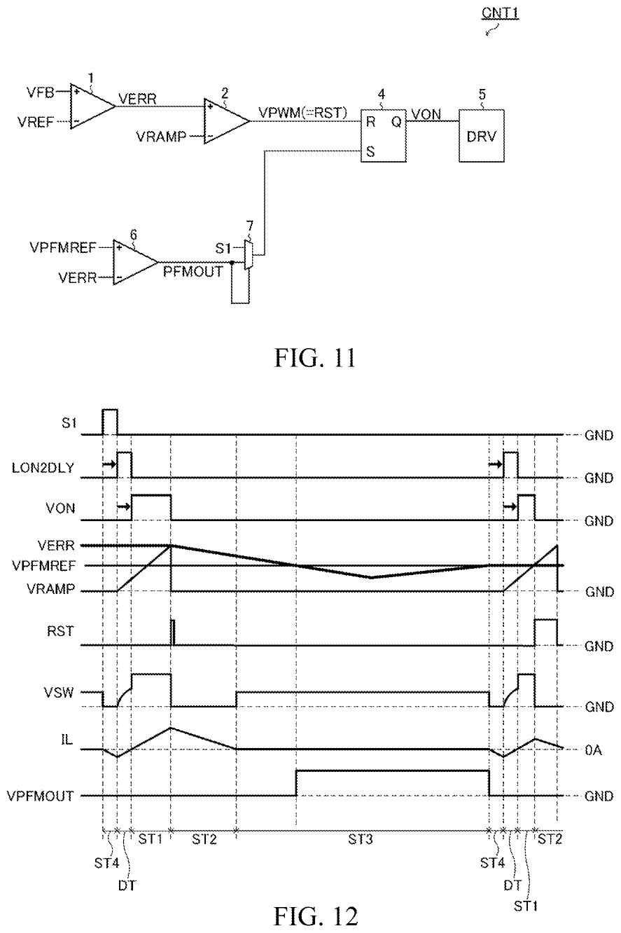

FIG. 11 shows a diagram of a second configuration example of a control unit according to the fifth embodiment FIG. 12 shows a timing diagram of operations of the control unit in FIG. 11. Moreover, in this configuration example, the description of parts identical to those of the first configuration example is appropriately omitted.

The control unit CNT1 shown in FIG. 11 includes an error amplifier 1, a PWM comparator 2, an RS flip-flop 4, a driver 5, a PFM comparator 6 and a selector 7.

In this configuration example, the PWM signal VPWM becomes a reset signal RST.

The selector 7 selects the period signal S1 when the signal VPWM is at a low level. The selector 7 selects the signal VPFMOUT when the signal VPWM is at a high level.

The control unit CTN1 shown in FIG. 11 determines that the load LD1 is in a light load state when the error signal VERR exceeds the reference voltage VPFMREF.

### Third Configuration Example of Control Unit of Fifth Embodiment

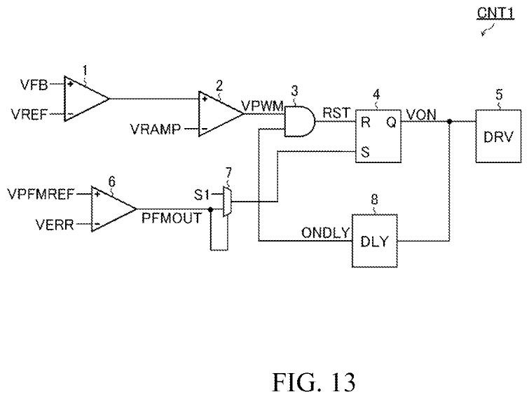

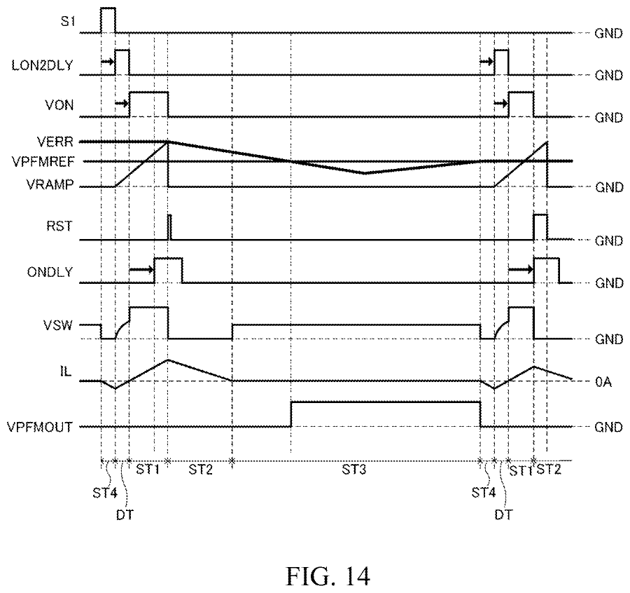

FIG. 13 shows a diagram of a third configuration example of a control unit according to the fifth embodiment. FIG. 14 shows a timing diagram of operations of the control unit in FIG. 13. Moreover, in this configuration example, the description of parts identical to those of the second configuration example is appropriately omitted.

The control unit CTN1 shown in FIG. 13 is the control unit CNT1 shown in FIG. 11 added with an AND gate 3 and a delay circuit 8.

Apart from the difference that the delay circuit 8 generates only the delay signal ONDLY, the AND gate 3 and the delay circuit 8 are identical to those of the first configuration example.

The control unit CTN1 shown in FIG. 13 determines that the load LD1 is in a light load state when the error signal VERR exceeds the reference voltage VPFMREF.

The control unit CNT1 shown in FIG. 13 uses the delay signal ONDLY, and sets a minimum time (the first predetermined time) of the first state ST1 when the load LD1 is in a light load state. Accordingly, the duration of the first state ST1 does not become inadequately short, hence better facilitating normal switch control.

### Variation Example of the Fifth Embodiment

As described above, the switching power device of the fifth embodiment is a switching power device improved from the switching power device of the first embodiment. However, the similar improvement may also be implemented for the switching power devices of the second to fourth embodiments. In addition, variations described in the variation examples of the first to fourth embodiments may also be implemented for the switching power device of the fifth embodiment.

### Sixth Embodiment

In the control unit CNT1 of the switching power device of each of the first to fourth embodiments, the duration of the first state ST1 lengthens as the load of the load LD1 gets heavier. That is to say, in the switching power devices of the first to fifth embodiments, it is gets more difficult to perform the control within the fixed period Tfix as the pulse width of the control signal used to control the switch SW1 gets broader.

The switching power device of the sixth embodiment is a switching power device capable solving the above issue of the switching power devices of the first to fifth embodiments.

The switching power device of the sixth embodiment is a switching power device improved from the switching power device of the first embodiment. Thus, in the sixth embodiment, the description of configuration and operation details identical to those of the first embodiment is omitted herein.

The control unit CNT1 of the sixth embodiment repeats the first state ST1, the second state ST2, the third state ST3 and the fourth state ST4 based on the fixed period of the period signal S1. Thus, the switching power device of the sixth embodiment is capable of fixing the switching frequency in synchronization with the period signal S1.

The control unit CNT1 of the sixth embodiment masks the period signal S1 until the detection of the zero crossing point of the inductor current IL. Thus, the control unit CNT1 of the sixth embodiment does not operate in synchronization with the period signal S1 when the load LD1 is in a heavy load state heavier than a usual load state. Accordingly, in the switching power device of the sixth embodiment, normal switching control can be easily performed even when the load LD1 is in a heavy load state.

The control unit CTN1 of the sixth embodiment sets a dead time period DT, in which the first switch SW1 and the second switch SW2 are turned off, between the fourth state ST4 and the first state ST1. Moreover, without any part deviations, the control unit CNT1 of the sixth embodiment sets the duration of the dead time period DT and the duration of the fourth state ST4 to fixed values, respectively, by way of initiating the first state at a zero crossing point of the inductor current IL. Accordingly, the switching power device of the sixth configuration is capable of reducing loss when the first switch is on, hence further achieving high efficiency.

### First Configuration Example of Control Unit of Sixth Embodiment

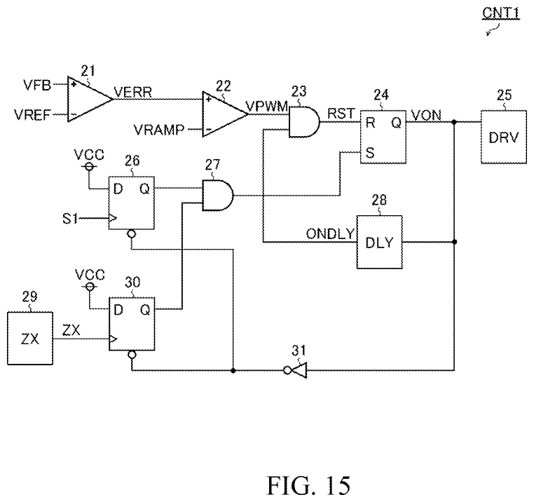

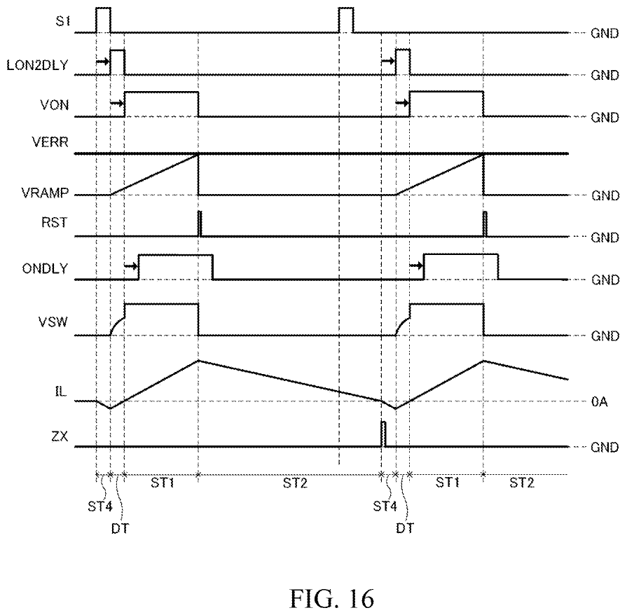

FIG. 15 shows a diagram of a first configuration example of the control unit CNT1 according to the sixth embodiment. FIG. 16 shows a timing diagram of operations of the control unit CNT1 in FIG. 15.

The control unit CNT1 shown in FIG. 15 includes an error amplifier 21, a PWM comparator 22, an AND gate 23, a latch circuit 24, a driver 25, a latch circuit 26, an AND gate 27, a delay circuit 28, a zero crossing point detection circuit 29, a latch circuit 30 and a NOT gate 31. Moreover, in the configuration shown in FIG. 15, an RS flip-flop is used as an example of the latch circuit 24, and a D flip-flop is used as an example of each of the latch circuits 26 and 30. Thus, the following description is given by using an RS flip-flop 24 as the latch circuit 24, and using a D flip-flop 26 as the latch circuit 26 and a D flip-flop circuit 30 as the latch circuit 30.

The error amplifier 21 outputs an error signal VERR corresponding to a difference between the feedback signal VFB output from the output feedback unit FB1 and the reference voltage VREF.

The PWM comparator 22 outputs a comparison result of the error signal VERR and the ramp voltage VRAMP, that is, a PWM signal VPWM.

The AND gate 23 outputs a logical product of the PWM signal VPWM and the delay signal ONDLY, that is, a reset signal RST. Details of the delay signal ONDLY are to be described below.

The RS flip-flop 24 delays in the RS flip-flop 24 a signal supplied to a setting terminal (an S terminal) to generate a delay signal LON2DLY. The RS flip-flop 24 generates and output an on-time setting voltage VON set by the delay signal LON2DLY and reset by a reset signal RST.

The driver 25 controls the first switch SW1 and the second switch SW2 based on the on-time setting voltage VON.

The D flip-flop 27 stores a voltage VCC supplied to a D terminal in synchronization with the period signal S1. A value of the voltage VCC supplied to the D terminal of the D flip-flop 26 is set to a value processed as a high level signal in the AND gate 27. The D flip-flop 26 is cleared by a logic inverted signal of the on-time setting voltage VON output from the NOT gate 31.

The AND gate 27 supplies a logical product of the output of the flip-flop 26 and the output of the D flip-flop 30 to a setting terminal (an S terminal) of the RS flip-flop 24.

The delay circuit 28 generates the delay signal ONDLY that delays the on-time setting voltage VON by a predetermined time.

The zero crossing point detection circuit 29 detects a zero crossing point of the inductor current IL, and outputs a zero crossing point detection signal ZX. The zero crossing point detection signal ZX output from the zero crossing point detection circuit 29 becomes a high level when the inductor current IL decreases from positive and reaches the zero crossing point.

The D flip-flop 30 stores the voltage VCC supplied to a D terminal in synchronization with the zero crossing point detection signal ZX. A value of the voltage VCC supplied to the D terminal of the D flip-flop 26 is set to a value processed as a high level signal in the AND gate 27. The D flip-flop 30 is cleared by a logic inverted signal of the on-time setting voltage VON output from the NOT gate 31.

The NOT gate 31 supplies the logic inverted signal of the on-time setting voltage VON to the respective clear terminals of the D flip-flops 26 and 30.

The control unit CNT1 shown in FIG. 15 initiates the fourth state ST4 upon the detection of a zero crossing point of the inductor current IL when the zero crossing point of the inductor current IL is detected after the pulse of the period signal S1 is generated. Accordingly, when the zero crossing point of the inductor current IL is detected after the pulse of the period signal S1 is generated, that is, in a condition of a heavy load, the switching frequency can be varied according to the size of the load. That is, to say, the load responsiveness under a heavy load can be optimized.

### Second Configuration Example of Control Unit of Sixth Embodiment

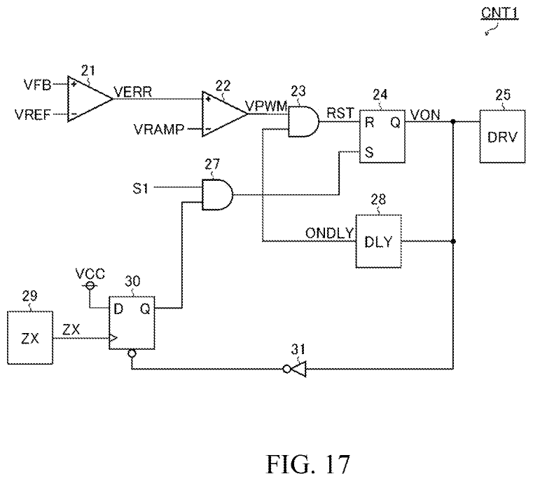

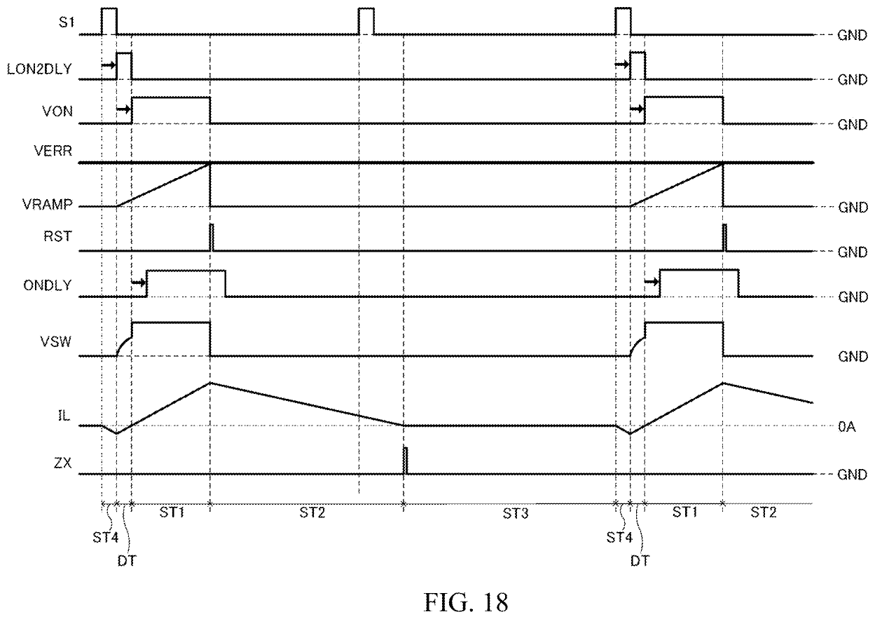

FIG. 17 shows a diagram of a second configuration example of a control unit according to a sixth embodiment. FIG. 18 shows a timing diagram of operations of the control unit in FIG. 17. Moreover, in this configuration example, the description of parts identical to those of the first configuration example is appropriately omitted.

The control unit CNT1 shown in FIG. 17 is a configuration in which the D flip-flop 26 is removed from the control unit CNT1 shown in FIG. 15. In the control unit CNT1 shown in FIG. 17, the AND gate 27 supplies a logical product of the period signal S1 and the output of the D flip-flop 30 to the setting terminal (the S terminal) of the RS flip-flop 24.

The control unit CNT1 shown in FIG. 17 initiates the fourth state ST4 at a timing of a next pulse of the period signal S1 subsequent to the detection of a zero crossing point of the inductor current IL when the zero crossing point of the inductor current IL is detected after the pulse of the period signal S1 is generated. Accordingly, when the zero crossing point of the inductor current IL is detected after the pulse of the period signal S1 is generated, that is, in a condition of a heavy load, the switching frequency can be varied in a multiple of the frequency of the period signal S1. That is to say, the switching frequency can be discretized and limited.

### Variation Example of Sixth Embodiment

As described above, the switching power device of the sixth embodiment is a switching power device improved from the switching power device of the first embodiment. However, the similar improvement may also be implemented for the switching power devices of the second to fifth embodiments. In addition, variations described in the variation examples of the first to fifth embodiments may also be implemented for the switching power device of the sixth embodiment.

### Seventh Embodiment

The control unit CNT1 of the switching power device of each of the first to sixth embodiments sets the duration of the fourth state ST4 to be fixed. Thus, in the switching power devices of the first to sixth embodiments, when the input voltage VIN varies, the regenerated energy of the inductor current IL accumulated in the fourth state ST4 becomes an amount unsuitable for soft switching of the switch SW1. That is to say, in the switching power devices of first to sixth embodiments, efficiency degrades when the input voltage VIN varies.

The switching power device of the seventh embodiment is a switching power device capable solving the above issue of the switching power devices of the first to sixth embodiments.

The switching power device of the seventh embodiment is a switching power device improved from the switching power device of the first embodiment. Thus, in the seventh embodiment, the description of configuration and operation details identical to those of the first embodiment is omitted herein.

The control unit CNT1 of the seventh embodiment repeats the first state ST1, the second state ST2, the third state ST3 and the fourth state ST4 in a fixed period. Thus, the switching power device of the seventh embodiment is capable of fixing the switching frequency.

In the control unit CNT1 of the seventh embodiment, the duration of the fourth state ST4 lengthens as the input voltage VIN increases. Accordingly, at an ending time point of a dead time period to be described shortly, the switching voltage VSW is greater than the input voltage VIN, hence preventing a current from flowing from the inductor L1 through a parasitic diode of the first switch SW1 to the application end of the input voltage VIN. Thus, the switching power device of the seventh configuration is capable of achieving high efficiency regardless of a value of the input voltage.

The control unit CTN1 of the seventh embodiment sets a dead time period DT, in which the first switch SW1 and the second switch SW2 are turned off, between the fourth state ST4 and the first state ST1. Moreover, without any part deviations, the control unit CNT1 of the seventh embodiment respectively sets the duration of the dead time period DT and the duration of the fourth state ST4 to fixed values when the input voltage VIN is a certain value by way of initiating the first state at a zero crossing point of the inductor current IL. Accordingly, the switching power device of the seventh configuration is capable of reducing loss when the first switch is on, hence further achieving high efficiency.

### First Configuration Example of Control Unit of Seventh Embodiment

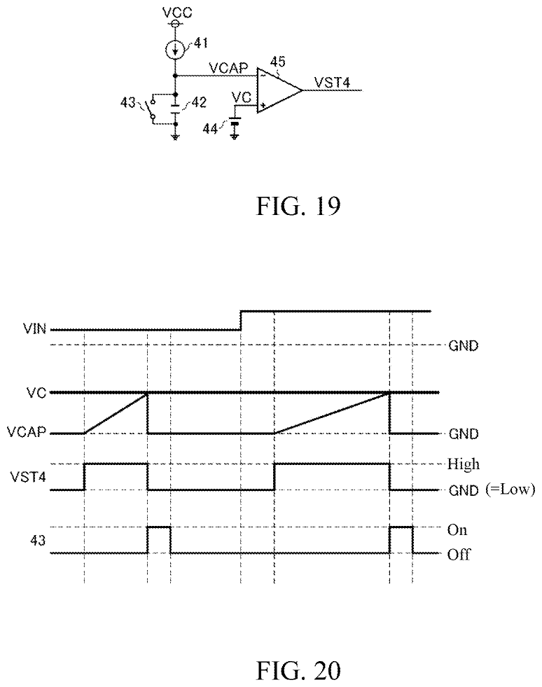

FIG. 19 shows a diagram of a first configuration example of a setting circuit according to a seventh embodiment. FIG. 20 shows a timing diagram of operations of the setting circuit in FIG. 19.

The first configuration example of the control unit CNT1 of the seventh embodiment includes the setting circuit shown in FIG. 19. The setting circuit shown in FIG. 19 includes a current source 41, a capacitor 42, a short-circuit switch 43, a voltage source 44 and a comparator 45.

The current source 41 outputs a current that is inversely proportional to the input voltage VIN.

The capacitor 42 is charged by the current source 41. During a charging period of the capacitor 42, a charged voltage VCAP of the capacitor 42 rises at a slope that is inversely proportional to the input voltage VIN.

The short-circuit switch 43 is on when the charged voltage VCAP of the capacitor 42 exceeds a constant voltage VC, such that two ends of the capacitor 42 are shorted and the capacitor 42 is discharged.

The voltage source 44 outputs a constant voltage VC.

The comparator 45 outputs a comparison result of the charged voltage VCAP of the capacitor and the constant voltage VC, that is, a voltage VST4. The first configuration example of the control unit CNT1 of the seventh embodiment sets a period in which the voltage VST4 is at a high level as the fourth state.

### Second Configuration Example of Control Unit of Seventh Embodiment

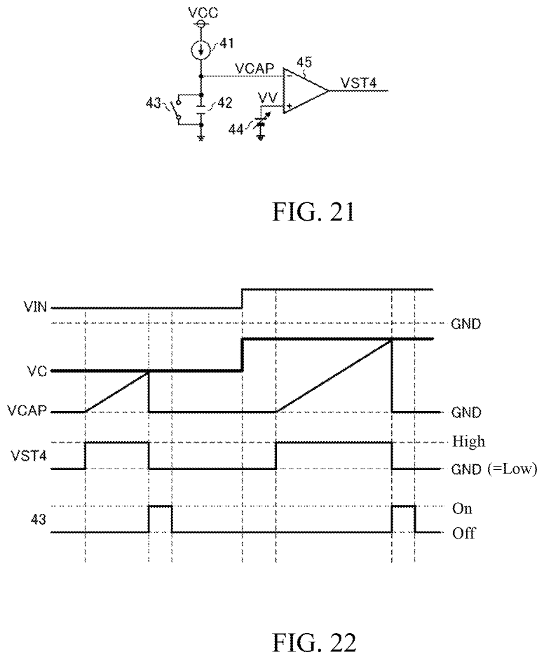

FIG. 21 shows a diagram of a second configuration example of a setting circuit according to the seventh embodiment. FIG. 22 shows a timing diagram of operations of the setting circuit in FIG. 21.

The second configuration example of the control unit CNT1 of the seventh embodiment includes the setting circuit shown in FIG. 21. The setting circuit shown in FIG. 21 includes a current source 41, a capacitor 42, a short-circuit switch 43, a voltage source 44 and a comparator 45.

The current source 41 outputs a constant current.

The capacitor 42 is charged by the current source 41. During a charging period of the capacitor 42, a charged voltage VCAP of the capacitor 42 rises at a predetermined slope.

The short-circuit switch 43 is on when the charged voltage VCAP of the capacitor exceeds a variable voltage VV, such that two ends of the capacitor 42 are shorted and the capacitor 42 is discharged.

The current source 44 outputs the variable voltage VV that is proportional to the input voltage VIN.

The comparator 45 outputs a comparison result of the charged voltage VCAP of the capacitor and the variable voltage VV, that is, a voltage VST4. The second configuration example of the control unit CNT1 of the seventh embodiment sets a period in which the voltage VST4 is at a high level as the fourth state.

### Variation Example of Seventh Embodiment

As described above, the switching power device of the seventh embodiment is a switching power device improved from the switching power device of the first embodiment. However, the similar improvement may also be implemented for the switching power devices of the second to sixth embodiments. In addition, variations described in the variation examples of the first to sixth embodiments may also be implemented for the switching power device of the seventh embodiment.

### Eighth embodiment

The control unit CNT1 of the switching power device of each of the fifth to eighth embodiments sets the duration of the dead time period DT to be a fixed value. In the switching power devices of the fifth to seventh embodiments, due to part deviations, the duration of the dead time period DT slightly deviates from an appropriate duration, leading to a concern of increased loss when the switch SW1 is on and degraded efficiency.

The switching power device of the eighth embodiment is a switching power device capable solving the above issue of the switching power devices of the fifth to seventh embodiments.

The switching power device of the eighth embodiment is a switching power device improved from the switching power device of the first embodiment. Thus, in the eighth embodiment, the description of configuration and operation details identical to those of the first embodiment is omitted herein.

The control unit CNT1 of the eighth embodiment repeats the first state ST1, the second state ST2, the third state ST3 and the fourth state ST4 in a fixed period. Thus, the switching power device of the eighth embodiment is capable of fixing the switching frequency.

The control unit CTN1 of the eighth embodiment sets the dead time period DT, in which the first switch SW1 and the second switch SW2 are turned off, between the fourth state ST4 and the first state ST1. In addition, the control unit CNT1 of the eighth embodiment sets the duration of the fourth state ST4 to be a fixed value. Moreover, the control unit CNT1 of the eighth embodiment adjusts the duration of the dead time period. Accordingly, in the presence of property deviations of parts, the switching power device of the eighth embodiment is also capable of reducing loss when the first switch SW1 is on. Thus, even in the presence of property deviations of parts, the switching power device of the eighth configuration is also capable of further achieving high efficiency.

### First Configuration Example of Control Unit of Eighth Embodiment

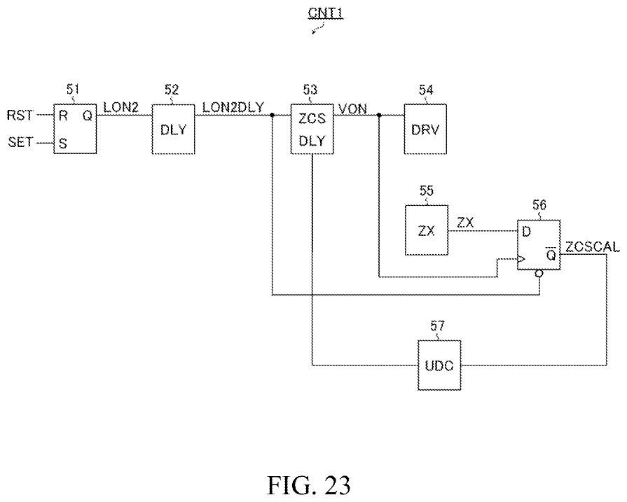

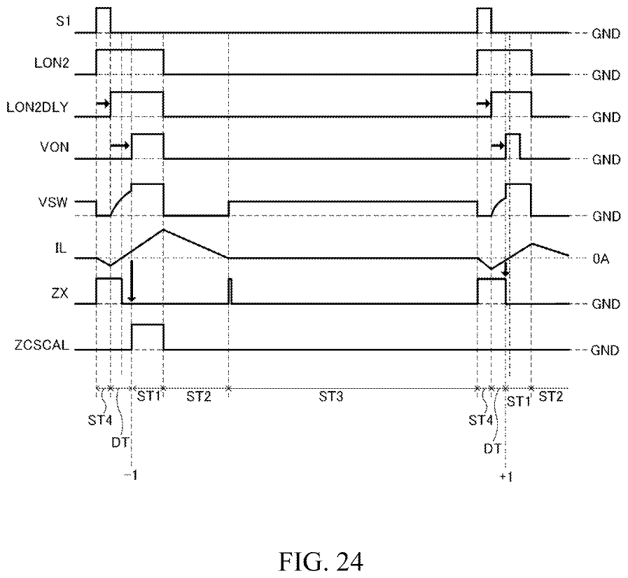

FIG. 23 shows a diagram of a first configuration example of the control unit CNT1 according to the eighth embodiment. FIG. 24 shows a timing diagram of operations of the control unit CNT1 in FIG. 23.

The control unit CNT1 shown in FIG. 23 includes a latch circuit 51, a delay circuit 52, a zero current switching delay circuit 53, a driver 54, a zero crossing point detection circuit 55, a latch circuit 56 and a reversible counter 57. In the configuration shown in FIG. 23, an RS flip-flop is used as an example of the latch circuit 51, and a D flip-flop is used as an example of the latch circuit 56. Thus, the following description is given by using an RS flip-flop 51 as the latch circuit 51, and using a D flip-flop 56 as the latch circuit 56.

The RS flip-flop 51 generates and outputs a signal LON2 set by a set signal SET supplied to a setting terminal (an S terminal) and reset by a reset signal RST supplied to a reset terminal (an R terminal). In this configuration example, the period signal S1 is used as the setting signal S1, and the PWM signal VPWM generated by a same method as that shown in FIG. 9 is used as the reset signal RST.

The delay circuit 52 generates a delay signal LON2DLY that delays a rising edge of the signal LON2 by a predetermined time and does not delay a falling edge of the signal LON2. The predetermined time is the duration of the fourth state ST4.

The zero current switching delay circuit 53 generates an on-time setting voltage VON that delays the signal LON2DLY by a variable time. The variable time is the duration of the dead time period DT. The variable time increases as a counter value of the reversible counter 57 gets larger.

The driver 54 controls the first switch SW1 and the second switch SW2 based on the on-time setting voltage VON.

The zero crossing point detection circuit 55 detects a zero crossing point of the inductor current IL, and outputs a zero crossing point detection signal ZX. The zero crossing point detection signal ZX output from the zero crossing point detection circuit 55 becomes a high level when the inductor current IL is negative and becomes a low level when the inductor current IL is non-negative.

The D flip-flow 56 stores the zero crossing point detection signal ZX in synchronization with the on-time setting voltage VON, and outputs an inverted signal of the stored zero crossing point detection signal ZX. The inverted signal of the zero crossing point detection signal ZX stored by the D flip-flop 56 is a signal ZCSCAL. The delay signal LON2DLY is supplied to a clear terminal of the D flip-flop 56. The D flip-flop 56 is cleared when the delay signal LON2DLY is at a low level, and the D flip-flop 56 is not cleared when the signal LON2DLY is at a high level.

The reversible counter 57 operates as follows: if the signal ZCSCAL is at a high level at a rising edge of the on-time setting voltage VON, the counter value is subtracted by 1; if the signal ZCSCAL is at a low level at a rising edge of the on-time setting voltage VON, the counter value is added by 1.

The control unit CNT1 shown in FIG. 23 operates as follows: if the inductor current IL is negative at an ending time point of the dead time period DT, the duration of the next dead time period DT is lengthened; if the inductor current IL is positive at the ending time point of the dead time period DT, the duration of the next dead time period DT is shortened. Thus, the control unit CNT1 shown in FIG. 23 is capable of causing a switching time point of the first switch SW1 to approximate a zero crossing point of the inductor current IL.

### Second Configuration Example of Control Unit of Eighth Embodiment

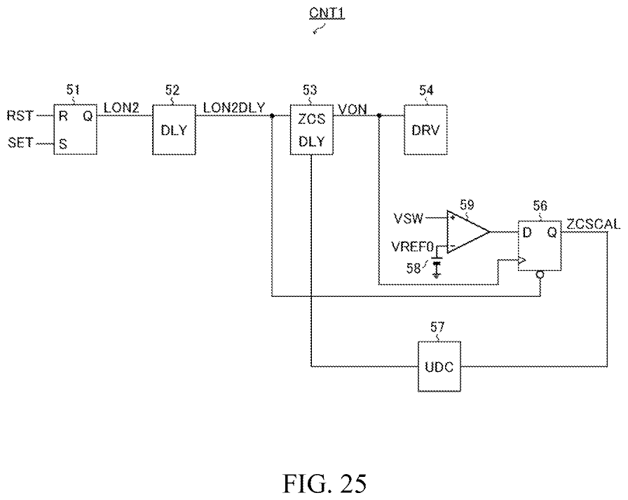

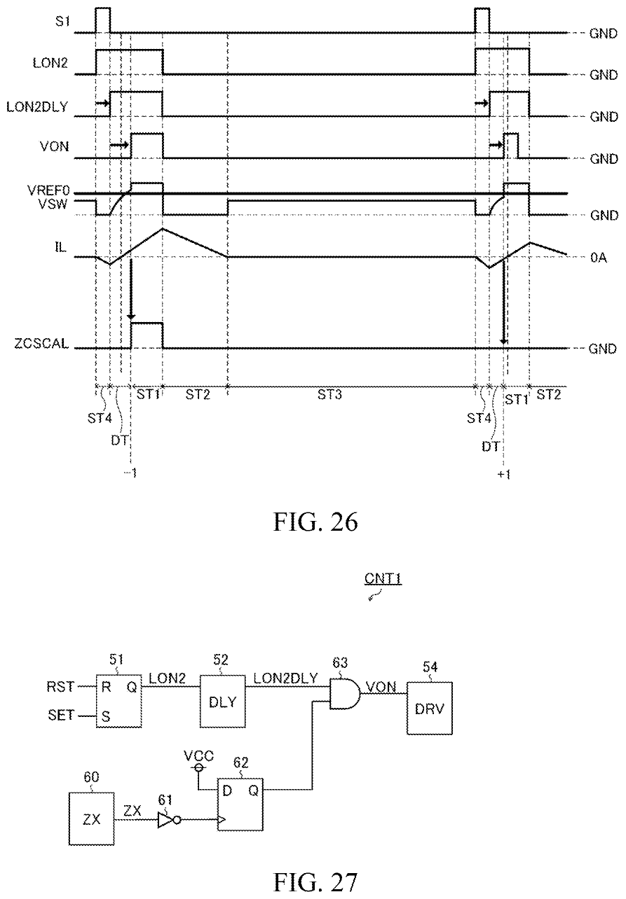

FIG. 25 shows a diagram of a second configuration example of the control unit CNT1 according to the eighth embodiment. FIG. 26 shows a timing diagram of operations of the control unit CNT1 in FIG. 25. Moreover, in this configuration example, the description of parts identical to those of the first configuration example is appropriately omitted.

The control unit CNT1 shown in FIG. 25 is a configuration in which the zero crossing point detection circuit 56 is removed from and the control unit CNT1 shown in FIG. 23, a power supply 58 and a comparator 59 are added, and the signal ZCSCAL is set to the zero crossing point detection signal ZX stored by the D flip-flop 56. In the control unit CNT1 shown in FIG. 25, the comparator 59 supplies a comparison result of the switching voltage VSW and a reference voltage VREF0 output from the power source 58 to the D terminal of the D flip-flop 56.

The control unit CNT1 shown in FIG. 25 operates as follows: if the switching voltage VSW less than the reference voltage VREF0 at an ending time point of the dead time period DT, the duration of the next dead time period DT is lengthened; if the switching voltage VSW is greater than the reference voltage VREF0 at the ending time point of the dead time period DT, the duration of the next dead time period DT is shortened. Thus, the control unit CNT1 shown in FIG. 25 is capable of causing an on time point the first switch SW1 to approximate a zero crossing point of the inductor current IL.

### Third Configuration Example of Control Unit of Eighth Embodiment

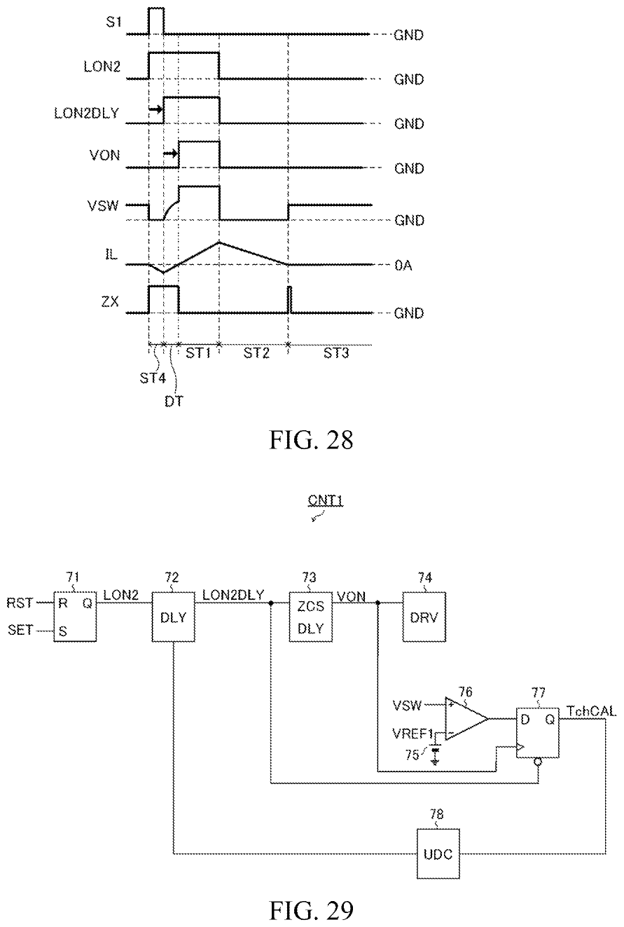

FIG. 27 shows a diagram of a third configuration example of the control unit CNT1 according to the eighth embodiment. FIG. 28 shows a timing diagram of operations of the control unit CNT1 in FIG. 27.

The control unit CNT1 shown in FIG. 27 includes a latch circuit 51, a delay circuit 52, a driver 54, a zero crossing point detection circuit 60, a NOT gate 61, a latch circuit 62 and an AND gate 63. In the configuration shown in FIG. 27, an RS flip-flop is used as an example of the latch circuit 51, and a D flip-flop is used as an example of the latch circuit 62. Thus, the following description is given by using an RS flip-flop 51 as the latch circuit 51, and using a D flip-flop 62 as the latch circuit 62.

The RS flip-flop 51 generates and outputs a signal LON2 set by a set signal SET supplied to a setting terminal (an S terminal) and reset by a reset signal RST supplied to a reset terminal (an R terminal). In this configuration example, the period signal S1 is used as the setting signal S1, and the PWM signal VPWM generated by a same method as that shown in FIG. 9 is used as the reset signal RST.

The delay circuit 52 generates a delay signal LON2DLY that delays the signal LON2 by a predetermined time. The predetermined time is the duration of the fourth state ST4.

The zero crossing point detection circuit 60 detects a zero crossing point of the inductor current IL, and outputs a zero crossing point detection signal ZX. The zero crossing point detection signal ZX output from the zero crossing point detection circuit 60 becomes a high level when the inductor current IL is negative and becomes a low level when the inductor current IL is non-negative.

The NOT gate 61 inverts the zero crossing point detection signal ZX output from the zero crossing point detection circuit 60. The D flip-flop 62 stores a voltage VCC supplied to the D terminal in synchronization with an inverted signal of the zero crossing point detection signal ZX, and outputs the stored voltage VCC. A value of the voltage VCC supplied to the D terminal of the D flip-flop 62 is set to a value processed as a high level signal in the AND gate 63.

The AND gate 63 generates a logical product of the delay signal LON2DLY and the output of the D flip-flop 62, that is, the on-time setting voltage VON.

The driver 54 controls the first switch SW1 and the second switch SW2 based on the on-time setting voltage VON.

The control unit CNT1 shown in FIG. 27 initiates the first state ST1 at a zero crossing point of the inductor current IL. Thus, the control unit CNT1 shown in FIG. 27 is capable of keeping a switching time point of the first switch SW1 to be substantially consistent with the zero crossing point of the inductor current IL.

### Variation Example of Eighth Embodiment

As described above, the switching power device of the eighth embodiment is a switching power device improved from the switching power device of the first embodiment. However, the similar improvement may also be implemented for the switching power devices of the second to seventh embodiments. In addition, variations described in the variation examples of the first to seventh embodiments may also be implemented for the switching power device of the eighth embodiment.

### Ninth Embodiment

The control unit CNT1 of the switching power device of each of the fifth, sixth and eighth embodiments sets the duration of the fourth state ST4 to be a fixed value. Further, in the control unit CNT1 in the switching power device of the seventh embodiment, the duration of the fourth state ST4 is fixed when the input voltage VIN does not vary. Thus, in the switching power devices of the fifth to eighth embodiments, due to part deviations, the duration of the fourth state ST4 slightly deviates from an appropriate duration, leading to a concern of increased loss when the switch SW1 is on and degraded efficiency. More particularly, when the duration of the fourth state ST4 is excessively long and the regenerated energy of the inductor L1 accumulated in the fourth state ST4 is overly large, the switching voltage VSW at the ending time point of the dead time period DT is greater than the input voltage VIN. As such, when the ending time point of the dead time period DT is greater than the input voltage VIN, the switching voltage VSW is greater than the input voltage VIN, a current flows from the inductor L1 through a parasitic diode of the first switch SW1 to the application end of the input voltage VIN, resulting in degraded efficiency.

The switching power device of the ninth embodiment is a switching power device capable solving the above issue of the switching power devices of the fifth to eighth embodiments.

The switching power device of the ninth embodiment is a switching power device improved from the switching power device of the first embodiment. Thus, in the ninth embodiment, the description of configuration and operation details identical to those of the first embodiment is omitted herein.

The control unit CNT1 of the ninth embodiment repeats the first state ST1, the second state ST2, the third state ST3 and the fourth state ST4 in a fixed period. Thus, the switching power device of the ninth embodiment is capable of fixing the switching frequency.

The control unit CTN1 of the ninth embodiment sets the dead time period DT, in which the first switch SW1 and the second switch SW2 are turned off, between the fourth state ST4 and the first state ST1. The control unit CNT1 of the ninth embodiment sets the duration of the dead time period DT to be a fixed value. Moreover, the control unit CNT1 of the ninth embodiment adjusts the duration of the fourth state. Accordingly, in the presence of property deviations of parts, the switching power device of the ninth embodiment is also capable of reducing loss when the first switch SW1 is on. Thus, even in the presence of property deviations of parts, the switching power device of the ninth configuration is also capable of further achieving high efficiency.

### First Configuration Example of Control Unit of Ninth Embodiment

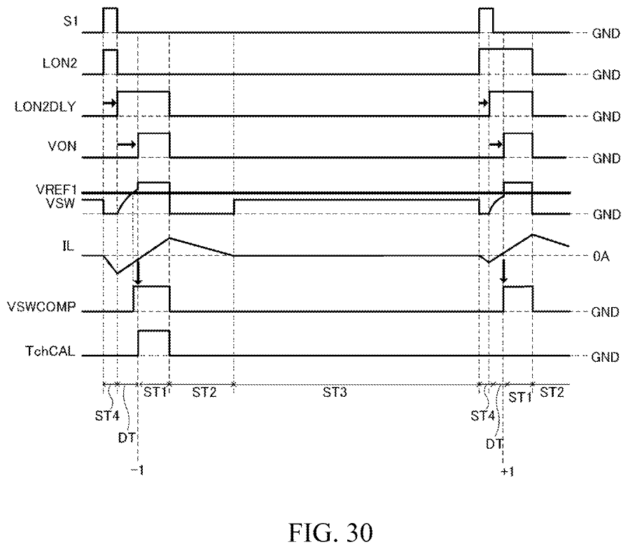

FIG. 29 shows a diagram of a first configuration example of the control unit CNT1 according to the ninth embodiment. FIG. 30 shows a timing diagram of operations of the control unit CNT1 in FIG. 29.

The control unit CNT1 shown in FIG. 29 includes a latch circuit 71, a delay circuit 72, a zero current switching delay circuit 73, a driver 74, a voltage source 75, a comparator 76, a latch circuit 77 and a reversible counter 78. In the configuration shown in FIG. 29, an RS flip-flop is used as an example of the latch circuit 71, and a D flip-flop is used as an example of the latch circuit 77. Thus, the following description is given by using an RS flip-flop 71 as the latch circuit 71, and using a D flip-flop 77 as the latch circuit 77.

The RS flip-flop 71 generates and outputs a signal LON2 set by a set signal SET supplied to a setting terminal (an S terminal) and reset by a reset signal RST supplied to a reset terminal (an R terminal). In this configuration example, the period signal S1 is used as the setting signal S1, and the PWM signal VPWM generated by a same method as that shown in FIG. 9 is used as the reset signal RST.

The delay circuit 72 generates a delay signal LON2DLY that delays the signal LON2 by a variable time. The variable time is the duration of the fourth state ST4. The variable time increases as a counter value of the reversible counter 78 gets larger.

The zero current switching delay circuit 73 generates an on-time setting voltage VON that delays the signal LON2DLY by a predetermined time. The predetermined time is the duration of the dead time period DT.

The driver 74 controls the first switch SW1 and the second switch SW2 based on the on-time setting voltage VON.

The voltage source 75 outputs a reference voltage VREF1.

The comparator 76 supplies a comparison result of the switching voltage VSW and the reference voltage VREF1 to the D terminal of the D flip-flop 77.

The D flip-flop 77 stores the comparison result of the comparator 76 in synchronization with the on-time setting voltage VON, and outputs the stored comparison result of the comparator 76. The comparison result of the comparator 76 stored by the D flip-flop is a signal TchCAL. A delay signal LON2DLY is supplied to a clear terminal of the D flip-flop 77. The D flip-flop 77 is cleared when the delay signal LON2DLY is at a low level, and the D flip-flop 77 is not cleared when the signal LON2DLY is at a high level.

The reversible counter 78 operates as follows: if the signal TchCAL is at a high level at a rising edge of the on-time setting voltage VON, the counter value is subtracted by 1; if the signal TchCAL is at a low level at a rising edge of the on-time setting voltage VON, the counter value is added by 1.

The control unit CNT1 shown in FIG. 29 operates as follows: if the switching voltage VSW less than the reference voltage VREF1 at an ending time point of the dead time period DT, the duration of the fourth state ST4 is lengthened; if the switching voltage VSW is greater than the reference voltage VREF1 at the ending time point of the dead time period DT, the duration of the fourth state ST4 is shortened. Thus, the control unit CNT1 shown in FIG. 29 is capable of causing the switching voltage VSW at an on time point the first switch to approximate the reference voltage VREF1.

### Second Configuration Example of Control Unit of Ninth Embodiment

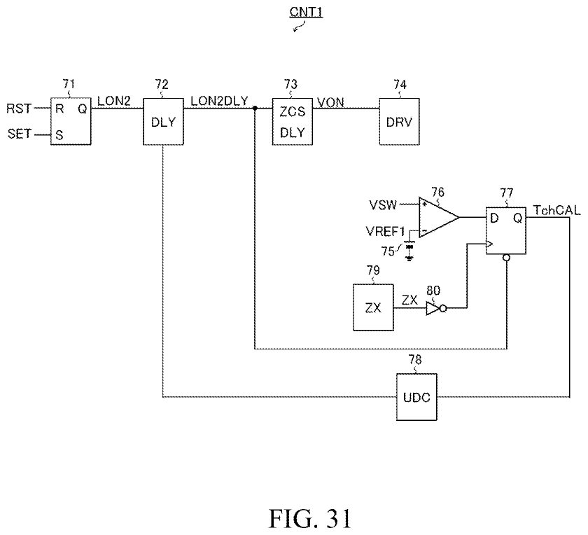

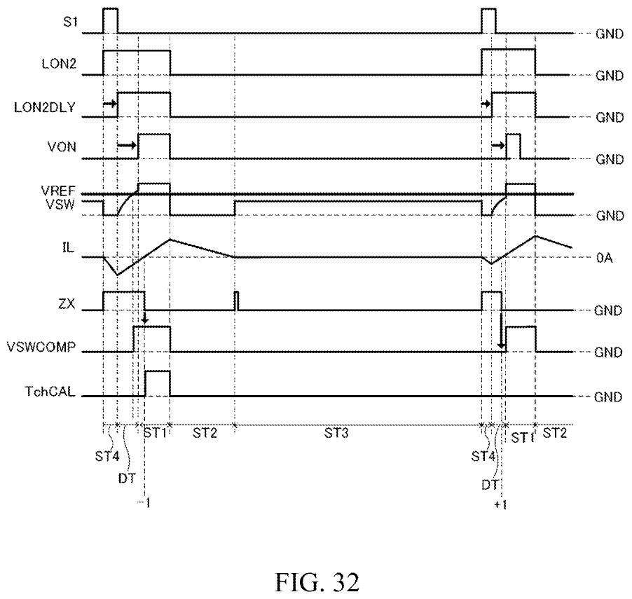

FIG. 31 shows a diagram of a second configuration example of the control unit CNT1 according to the ninth embodiment. FIG. 32 shows a timing diagram of operations of the control unit CNT1 in FIG. 31.

The control unit CNT1 shown in FIG. 31 is a configuration in which a zero crossing point detection circuit 79 and a NOT gate 80 are added to the control unit CNT1 shown in FIG. 29.

The zero crossing point detection circuit 79 detects a zero crossing point of the inductor current IL, and outputs a zero crossing point detection signal ZX. The zero crossing point detection signal ZX output from the zero crossing point detection circuit 79 becomes a high level when the inductor current IL is negative and becomes a low level when the inductor current IL is non-negative. The NOT gate 80 inverts the zero crossing point detection signal ZX.

The D flip-flop 77 stores a comparison result of the comparator 76 in synchronization with an inversion of the zero crossing point detection signal ZX, and outputs the stored comparison result of the comparator 76.

The reversible counter 78 operates as follows: if the signal TchCAL is at a high level at the zero crossing point of the inductor current IL, the counter value is subtracted by 1; if the signal TchCAL is at a low level at the zero crossing point of the inductor current IL, the counter value is added by 1.

The control unit CNT1 shown in FIG. 31 operates as follows: if the switching voltage VSW less than the reference voltage VREF1 at the zero crossing point of the inductor current IL, the duration of the fourth state ST4 is lengthened; if the switching voltage VSW is greater than the reference voltage VREF1 at the zero crossing point of the inductor current IL, the duration of the fourth state ST4 is shortened. Thus, the control unit CNT1 shown in FIG. 31 is capable of causing the switching voltage VSW at an on time point the first switch to approximate the reference voltage VREF1.

### Third Configuration Example of Control Unit of Ninth Embodiment

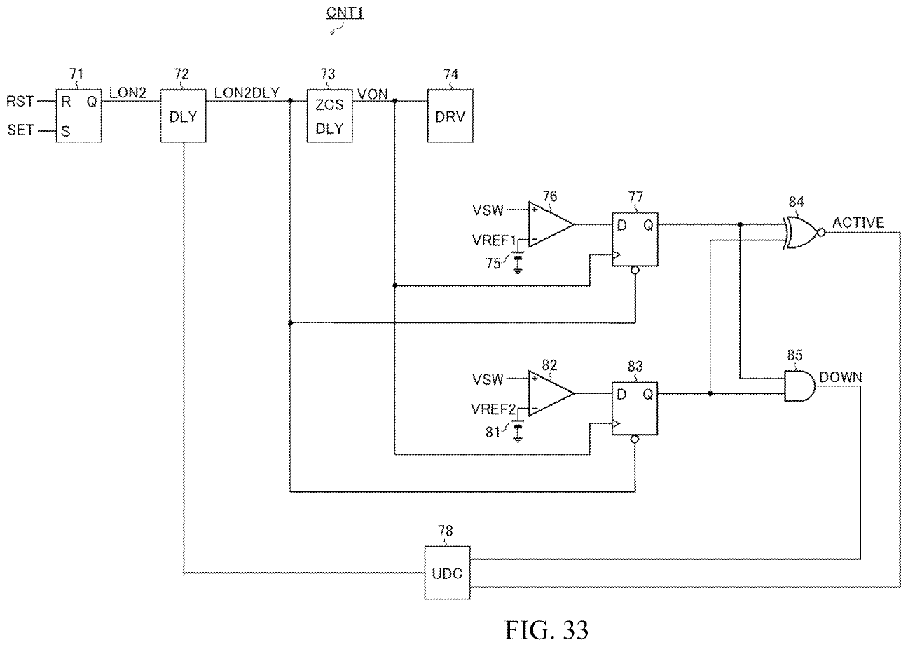

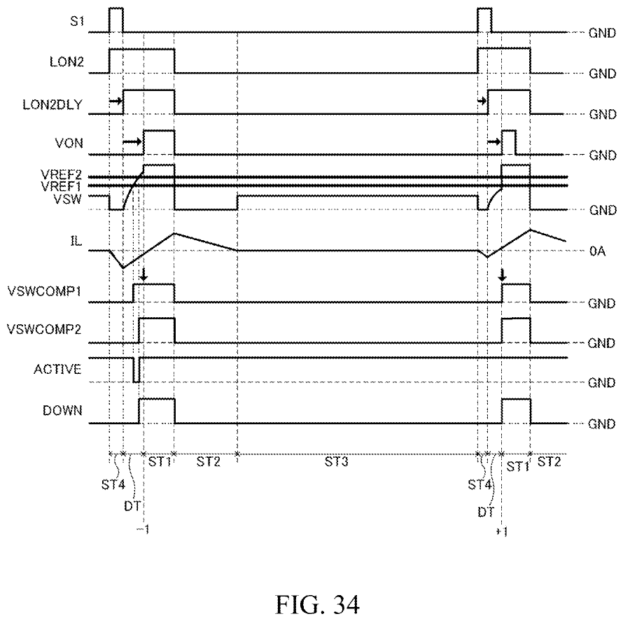

FIG. 33 shows a diagram of a third configuration example of the control unit CNT1 according to the ninth embodiment. FIG. 34 shows a timing diagram of operations of the control unit CNT1 in FIG. 33.

The control unit CNT1 shown in FIG. 33 is a configuration in which a voltage source 81, a comparator 82, a latch circuit 83, an EXOR gate 84 and an AND gate 85 are added to the control unit CNT1 shown in FIG. 31. Moreover, in the configuration shown in FIG. 33, a D flip-flop is used as an example of the latch circuit 83. Thus, the following description is given by using a D flip-flop 83 as the latch circuit 83.

The voltage source 81 outputs a reference voltage VREF2. The reference voltage VREF2 is greater than the reference voltage VREF1.

The comparator 82 supplies a comparison result of the switching voltage VSW and the reference voltage VREF2 to a D terminal of the D flip-flop 83.

The D flip-flop 83 stores the comparison result of the comparator 82 in synchronization with the on-time setting voltage VON, and outputs the stored comparison result of the comparator 82. A delay signal LON2DLY is supplied to a clear terminal of the D flip-flop 83. The D flip-flop 83 is cleared when the delay signal LON2DLY is at a low level, and the D flip-flop 83 is not cleared when the signal LON2DLY is at a high level.

The EXOR gate 84 generates and outputs an inverted signal of a mutually exclusive logical sum of an output of the D flip-flip 77 and output of the D flip-flop 83, that is, a signal ACTIVE, to the reversible counter 78.

The AND gate 85 generates and outputs a logical product of the output of the D flip-flip 77 and the output of the D flip-flop 83, that is, a signal DOWN, to the reversible counter 78.

The reversible counter 78 does not count when the signal ACTIVE is at a low level. In addition, when the signal ACTIVE is at a high level and the signal DOWN is at a high level at a rising edge of the on-time setting voltage VON, the reversible counter substrates the counter value by 1; when the signal ACTIVE is at a high level and the signal DOWN is at a low level at a rising edge of the on-time setting voltage VON, the reversible counter adds the counter value by 1. Moreover, in FIG. 34, the signal DOWN appears to be at a high level at a time point at which the counter value of the reversible counter 78 is added by 1. However, since the first switch SW1 is turned on with slight delay with respect to the rising edge of the on-time setting voltage VON, the switching voltage VSW is slightly delayed with respect to the rising edge of the on-time setting voltage VON and rises drastically. Thus, in FIG. 34, the switching voltage VSW has not yet reached the reference voltage VREF1 and the signal DOWN is at a low level at the time point at which the counter value of the reversible counter 78 is added by 1.

The control unit CNT1 shown in FIG. 33 operates as follows: if the switching voltage VSW less than the reference voltage VREF1 at an ending time point of the dead time period DT, the duration of the fourth state ST4 is lengthened; if the switching voltage VSW is greater than the reference voltage VREF2 at the ending time point of the dead time period DT, the duration of the fourth state ST4 is shortened. Thus, the control unit CNT1 shown in FIG. 33 is capable of causing an on time point the first switch to approximate a range of greater the reference voltage VREF1 and less than the reference voltage VREF2.

### Variation Example of Ninth Embodiment

As described above, the switching power device of the ninth embodiment is a switching power device improved from the switching power device of the first embodiment. However, the similar improvement may also be implemented for the switching power devices of the second to eighth embodiments. In addition, variations described in the variation examples of the first to eighth embodiments may also be implemented for the switching power device of the ninth embodiment.

### Use

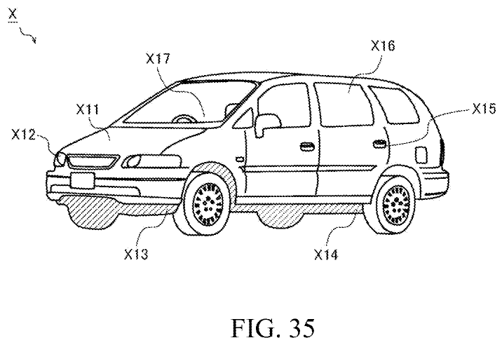

Next, examples of use of the switching circuit 1 described above are to be given below. FIG. 35 shows a diagram of an appearance of a configuration example of a vehicle mounted with a vehicle device. A vehicle X of this configuration example is mounted with vehicle devices X11 to X17, and a battery (not shown) powering these vehicles X11 to X17.

When the switching power device of any one of the first to ninth embodiments described above is mounted in the vehicle X, radiation noise of the amplitude modulation (AM) band can be inhibited without undesirably affecting the reception of AM radio broadcasting. Thus, it is desired that a switch control circuit 1 cause a voltage of more than 1.8 megahertz (MHz) and less than 2.1 MHz to be generated at the connection node between the first switch SW1 and the second switch SW2 when the load LD1 is in a usual load state. That is to say, it is desired that the switch control circuit 1 set the frequency (switching frequency) of the switching voltage VSW to be more than 1.8 MHz and less than 2.1 MHz. This is because the radiation noise of the AM band increases when the switching frequency is not yet 1.8 MHz, and the switching loss exceeds a tolerable range when the switching frequency is more than 2.1 MHz.

The vehicle device X11 is an engine control unit that performs engine-related control (fuel injection control, electronic throttle control, idle speed control, oxygen sensor heater control, and automatic cruise control).

The vehicle device X12 is a lamp control unit that performs dimming and lighting control of a high intensity discharged lamp (HID) or a daytime running lamp (DRL).

The vehicle device X13 is a transmission device control unit that performs transmission device-related control.

The vehicle device X14 is a vehicle body control unit that performs motion-related control of the vehicle X such as anti-lock brake system (ABS) control, electric power steering control and electronic suspension control.

The vehicle device X15 is a safety control unit that performs driving control such as door lock and antitheft alarm.

The vehicle device 16X is, for example, an electronic apparatuses including a wiper, power rearview mirror, power window, power sunroof, and power seat, which is assembled on the vehicle X at the factory stage as standard accessories or manufacturer options.

The vehicle device X17 is, for example, an electronic apparatus including a vehicle audiovisual (AV) device, car navigation system, and electronic toll collection (ETC) system, and automatic toll collection system, which can be mounted on vehicle X as a user option as desired.

In addition, the switching power device of each of the first to ninth embodiments described above can be assembled on any one of the vehicle devices X11 to X17.

### Notes

Moreover, in addition to the embodiments, various modifications may be applied to the configurations of the present disclosure without departing from the scope of the technical inventive subject thereof. It should be understood that all aspects of the embodiment are exemplary rather than restrictive, and it should also be understood that the technical scope of the present disclosure is not limited to the description associated with the embodiment, but includes all modifications of equivalent meanings of the claims within the scope.

For example, the setting value of the fixed period Tfix may also be variable. By changing the period of the period signal S1, the setting value of the fixed period Tfix can be varied.

A switching power device (1A to 1D) according to one aspect of the above description is configured as (a first configuration), that is, configured to step down an input voltage to an output voltage, and including: a first switch (SW1), having a first end connectable to an application end of the input voltage, and a second end connectable to a first end of an inductor (L1); a second switch (SW2), having a first end connectable to the first end of the inductor and the second end of the first switch; and a second end connectable to a low voltage application end having a voltage less than the input voltage; and a control unit (CNT1), configured to control on/off of the first switch and the second switch. The control unit includes: a first state, in which the first switch is on and the second switch is off; a second state, in which the first switch is off and the second switch is on; a third state, in which the first switch and the second switch are off; and a fourth state, in which a voltage of a connection node between the first switch and the second switch is less than that in the third state. The first state, the second state, the third state and the fourth state are repeated, and when the input voltage is increased, a duration of the fourth state is lengthened.

The switching power device of the first configuration is capable of achieving high efficiency regardless of a value of the input voltage.

The switching power device of the first configuration may also be configured as (a second configuration), wherein the control unit repeats the first state, the second state, the third state and the fourth state in an order of the first state, the second state, the third state, and the fourth state.

The switching power device of the second configuration is capable of inhibiting loss when the first switch is on.

The switching power device of the first or second configuration may also be configured as (a third configuration), wherein the control unit repeats the first state, the second state, the third state and the fourth state in a fixed period.

The switching power device of the third configuration is capable of inhibiting variation in a switching frequency.

The switching power device of any one of the first to third configurations may also be configured as (a fourth configuration), wherein the control unit includes a current source configured to output a current inversely proportional to the input voltage, and a capacitor configured to be charged by the current source, wherein the duration of the fourth state is set based on a difference between a charged voltage of the capacitor and a constant voltage.

The switching power device of the fourth configuration has a simple structure, and can better lengthen the duration of the fourth state as the input voltage increases.

The switching power device of any one of the first to third configurations may also be configured as (a fifth configuration), wherein the control unit includes a current source configured to output a constant current, and a capacitor configured to be charged by the current source, wherein the duration of the fourth state is set based on a difference between a charged voltage of the capacitor and a voltage proportional to the input voltage.

The switching power device of the fifth configuration has a simple structure, and can better lengthen the duration of the fourth state as the input voltage increases.

The switching power device of any one of the first to fifth configurations may also be configured as (a sixth configuration), wherein the control unit provides a dead time period between the fourth state and the first state in which the first switch and the second switch are turned off, and the first state is initiated at a zero crossing point of a current flowing through the inductor.

The switching power device of the sixth configuration is capable of reducing loss when the first switch is on, thus further achieving high efficiency.

The switching power device of any one of the first to sixth configurations may also be configured as (a seventh configuration), wherein the control unit turns off the first switch and turns on the second switch in the fourth state.

The switching power device of the seventh configuration implements the fourth state by using simple control.

The switching power device of any one of the first to seventh configurations may also be configured as (an eighth configuration), including: a third switch (SW3), configured to be connectable in parallel to the second switch and having at least one of an on-resistance and a capacitance less than an on-resistance and a capacitance of the second switch; wherein, the control unit is configured to control on/off of the third switch, and the control unit turns off the first switch and turns on the third switch in the fourth state.

The switching power device of the eighth configuration is capable of reducing loss in the fourth state.

The switching power device of any one of the first to sixth configurations may also be configured as (a ninth configuration), including: a third switch (SW3), configured to have a first end connectable to the first end of the inductor and the second end of the first switch; and a capacitor (C2), having a first end connected to a second end of the third switch, and a second end connectable to the low voltage application end; wherein, the control unit is configured to control on/off of the third switch, and the control unit turns off the first switch and turns on the third switch in the fourth state.

The switching power device of the ninth configuration, by adjusting the capacitance value of the capacitor, is capable of adjusting a voltage rise at the connection node between the first switch and the second switch immediately after the fourth state ends.

The switching power device of the ninth configuration may also be configured as (a tenth configuration), including: a fourth switch (SW4), configured to be connectable in parallel to the capacitor; wherein, the control unit is configured to control on/off of the fourth switch, and the control unit complementarily controls on/off of the third switch and on/off of the fourth switch.

The switching power device of the tenth configuration is capable of appropriately discharging the capacitor.

The switching power device of any one of the first to sixth configurations may also be configured as (an eleventh configuration), including: a capacitor (C2), having a first end configured to be connectable to the first end of the inductor and the second end of the first switch, and having a second end configured to be connectable to an application end of a variable voltage; wherein, the control unit is configured to control the variable voltage, and the control unit turns off the first switch in the fourth state, and controls the variable voltage to generate a potential difference between the first end and the second end of the capacitor.

The switching power device of the eleventh configuration, by adjusting a value of a variable voltage, is capable of adjusting a voltage rise at the connection node between the first switch and the second switch immediately after the fourth state ends.

The switching power device of any one of the first to eleventh configurations may also be configured as (a twelfth configuration), wherein a voltage between 1.8 MHz and 2.1 MHz is generated at the connection node between the first switch and the second switch.

The switching power device of the twelfth configuration is capable of inhibiting radiation noise of the AM band. Moreover, the switching power device of the twelfth configuration is capable keeping switching loss within a tolerable range.

A switch control device (CNT1) according to one aspect of the above description is configured as (a thirteenth configuration), controlling on/off of a first switch (SW1) and on/off of a second switch (SW2), a first end of the first switch (SW1) being connectable to an application end of an input voltage, a second end of the first switch being connectable to a first end of an inductor (L1); a first end of the second switch (SW2) being connectable to the first end of the inductor and the second end of the first switch, and a second end of the second switch being connectable to a low voltage application end having a voltage less than the input voltage. The switch control device (CNT1) includes: a first state, in which the first switch is on and the second switch is off; a second state, in which the first switch is off and the second switch is on; a third state, in which the first switch and the second switch are off; and a fourth state, in which a voltage of a connection node between the first switch and the second switch is less than that in the third state. The first state, the second state, the third state and the fourth state are repeated, and when the input voltage is increased, a duration the fourth state is lengthened.

The switch control device of the thirteenth configuration is capable of achieving high efficiency regardless of a value of the input voltage.

A vehicle device (X11 to X17) according to one aspect of the above description is configured as (a fourteenth configuration), including the switching power device of any one of the first to twelfth configurations or the switch control device of the thirteenth configuration.

The vehicle device of the fourteenth configuration is capable of achieving high efficiency regardless of a value of the input voltage.

A vehicle (X) according to one aspect of the above description is configured as (a fifteenth configuration), including the vehicle device of the fourteenth configuration, and a battery supplying power to the vehicle device.

The vehicle of the fifteenth configuration is capable of achieving high efficiency regardless of a value of the input voltage.

1. A switching power device, configured to step down an input voltage to an output voltage, comprising:
a first switch, having:
a first end connectable to an application end of the input voltage; and
a second end connectable to a first end of an inductor;
a second switch, having:
a first end connectable to the first end of the inductor and the second end of the first switch; and
a second end connectable to a low voltage application end having a voltage less than the input voltage; and
a control unit, configured to control on/off of the first switch and the second switch, wherein
the control unit includes:
a first state, in which the first switch is on and the second switch is off;
a second state, in which the first switch is off and the second switch is on;
a third state, in which the first switch and the second switch are off; and
a fourth state, in which a voltage of a connection node between the first switch and the second switch is less than that in the third state;
the first state, the second state, the third state and the fourth state are repeated, and
when the input voltage is increased, a duration of the fourth state is prolonged.

2. The switching power device of claim 1, wherein the control unit repeats the first state, the second state, the third state and the fourth state in an order of the first state, the second state, the third state, and the fourth state.

3. The switching power device of claim 1, wherein the control unit repeats the first state, the second state, the third state and the fourth state in a fixed period.

4. The switching power device of claim 2, wherein the control unit repeats the first state, the second state, the third state and the fourth state in a fixed period.

5. The switching power device of claim 1, wherein the control unit includes:
a current source, configured to output a current inversely proportional to the input voltage; and
a capacitor, configured to be charged by the current source,
wherein the duration of the fourth state is set based on a difference between a charged voltage of the capacitor and a constant voltage.

6. The switching power device of claim 2, wherein the control unit includes:
a current source, configured to output a current inversely proportional to the input voltage; and
a capacitor, configured to be charged by the current source,
wherein the duration of the fourth state is set based on a difference between a charged voltage of the capacitor and a constant voltage.

7. The switching power device of claim 3, wherein the control unit includes:
a current source, configured to output a current inversely proportional to the input voltage; and
a capacitor, configured to be charged by the current source,
wherein the duration of the fourth state is set based on a difference between a charged voltage of the capacitor and a constant voltage.

8. The switching power device of claim 1, wherein the control unit includes:
a current source, configured to output a constant current; and
a capacitor, configured to be charged by the current source,
wherein the duration of the fourth state is set based on a difference between a charged voltage of the capacitor and a voltage proportional to the input voltage.

9. The switching power device of claim 2, wherein the control unit includes:
a current source, configured to output a constant current; and
a capacitor, configured to be charged by the current source,
wherein the duration of the fourth state is set based on a difference between a charged voltage of the capacitor and a voltage proportional to the input voltage.

10. The switching power device of claim 1, wherein
the control unit provides a dead time period between the fourth state and the first state in which the first switch and the second switch are turned off, and
the first state is initiated at a zero crossing point of a current flowing through the inductor.

11. The switching power device of claim 1, wherein the control unit turns off the first switch and turns on the second switch in the fourth state.

12. The switching power device of claim 1, further comprising:
a third switch, configured to be connectable in parallel to the second switch and
having at least one of an on-resistance and a capacitance less than an on-resistance and a capacitance of the second switch, wherein the control unit is configured to control on/off of the third switch, and the control unit turns off the first switch and turns on the third switch in the fourth state.

13. The switching power device of claim 1, further comprising:
a third switch, configured to have a first end connectable to the first end of the inductor and the second end of the first switch; and
a capacitor, having:
a first end connected to a second end of the third switch; and
a second end connectable to the low voltage application end,
wherein
the control unit is configured to control on/off of the third switch, and
the control unit turns off the first switch and turns on the third switch in the fourth state.

14. The switching power device of claim 13, further comprising:
a fourth switch, configured to be connectable in parallel to the capacitor, wherein
the control unit is configured to control on/off of the fourth switch, and
the control unit complementarily controls on/off of the third switch and on/off of the fourth switch.

15. The switching power device of claim 1, further comprising:
a capacitor, having a first end configured to be connectable to the first end of the inductor and the second end of the first switch, and having a second end configured to be connectable to an application end of a variable voltage, wherein
the control unit is configured to control the variable voltage, and
the control unit turns off the first switch in the fourth state, and controls the variable voltage to generate a potential difference between the first end and the second end of the capacitor.

16. The switching power device of claim 1, wherein a voltage between 1.8 MHz and 2.1 MHz is generated at the connection node between the first switch and the second switch.

17. A switch control device, which controls on/off of a first switch and on/off of a second switch, a first end of the first switch being connectable to an application end of an input voltage, a second end of the first switch being connectable to a first end of an inductor; a first end of the second switch being connectable to the first end of the inductor and the second end of the first switch, and a second end of the second switch being connectable to a low voltage application end having a voltage less than the input voltage, the switch control device comprising:
a first state, in which the first switch is on and the second switch is off;
a second state, in which the first switch is off and the second switch is on;
a third state, in which the first switch and the second switch are off; and
a fourth state, in which a voltage of a connection node between the first switch and the second switch is less than that in the third state;
the first state, the second state, the third state and the fourth state are repeated, and
when the input voltage is increased, a duration the fourth state is lengthened.

18. A vehicle device, comprising the switching power device of claim 1.

19. A vehicle device, comprising the switch control device of claim 17.

20. An automobile, comprising:
the vehicle device of claim 18; and
a battery supplying power to the vehicle device.
